(19) United States
(12) Patent Application Publication
(10) Pub. No.: US 2024/0264312 A1
(43) Pub. Date: Aug. 8, 2024

(54) SYSTEM AND METHOD FOR ROBOT LOCALISATION IN REDUCED LIGHT CONDITIONS

(71) Applicant: STARSHIP TECHNOLOGIES OÜ, Tallinn (EE)

(72) Inventor: Rasmus RAAG, Tallinn (EE)

(73) Assignee: STARSHIP TECHNOLOGIES OÜ, Tallinn (EE)

(21) Appl. No.: 18/629,817

(22) Filed: Apr. 8, 2024

Related U.S. Application Data
(63) Continuation of application No. 17/607,945, filed on Nov. 1, 2021, now abandoned.

(30) Foreign Application Priority Data
May 21, 2019 (EP) 19175789.7

(51) Int. Cl. G01S 17/894; G01S 7/497; G01S 17/86

(52) U.S. Cl. CPC G01S 17/894; G01S 7/497; G01S 17/86

(57) ABSTRACT

A method for localization using at least one time-of-flight (ToF) sensor, map data and a processing unit. The method can comprise capturing at least one ToF sensor image comprising at least one feature with the at least one ToF sensor. The method can further comprise the processing unit extracting at least one feature from the at least one ToF sensor image and the processing unit comparing the at least one extracted feature with the map data. A location hypothesis based on the comparison step can be generated and output. The present invention also relates to a localization system comprising a ToF sensor configured to capture a at least one ToF sensor image, a memory unit, comprising stored therein map data and a processing unit. The processing unit can be configured to extract at least one feature from the at least one ToF sensor image. The processing unit can further be configured to access the memory unit comprising the map data and compare the at least one extracted feature with the map data. The processing unit can generate a location hypothesis based on the comparison of the at least one extracted feature with the map data.

### RELATED APPLICATIONS

This application is a continuation of U.S. application Ser. No. 17/607,945, filed Nov. 1, 2021, which is the National phase (a 371) of International Application No. PCT/EP2020/063152, filed May 12, 2020, the entire contents of which are hereby fully incorporated herein by reference for all purposes. PCT/EP2020/063152 claims the priority benefit of European patent application 19175789.7, filed May 21, 2019, the entire contents of which are hereby fully incorporated herein by reference for all purposes.

### FILE OF THE INVENTION

The present invention relates generally to system and methods of localisation and mapping.

### INTRODUCTION

Increasingly, mobile robots are used to perform a wide array of tasks. Such robots are generally equipped with a plurality of sensors for enabling these tasks. One type of such robots are mobile delivery robots, such as those built by Starship Technologies. These robots can transport items between different locations. The robots can be used to automate so-called last-mile delivery—the last stretch of an item before it reaches the recipient. Other uses of these robots include vending of consumable items, pick up of returns, grocery deliveries, peer to peer deliveries and similar. For example, the applicant's international patent application WO 2017/064202 A1 discloses such mobile delivery robots.

Mobile delivery robots may travel in indoor and/or outdoor environments autonomously or partially-autonomously. They generally comprise various sensors for navigation, machine vision, mapping, localisation or motion.

There are various ways for such mobile robots to localise themselves in their surroundings. For example, GPS sensors may be utilized to estimate a location of the GPS sensor and consequently of the mobile robot comprising the GPS sensor. Odometers and gyroscopes can be used to measure relative movement of the mobile robot between two different poses. Accelerometers may be used for measuring acceleration, tilting and orientation of the mobile robot.

However, for certain tasks such as item delivery, precise localization may be required. Particularly advantageous mapping and localisation techniques are described in the patent applications WO 2017076928 A1 and WO 2017/076929 A1. The applications disclose using features such as lines detected in visual images captured by visual cameras to localise in outdoor surroundings based on a map built via the same features. That is, a mobile robot can utilize visual cameras and images captured from such visual cameras for mapping and localisation.

Though, the use of lines extracted from camera images can be quite advantageous during day-time (i.e. in good light conditions), they may be inefficient during low-light conditions (e.g. during night-time). Due to the low visibility, very few straight lines may be detected or extracted from an image captured at reduced light conditions, thus localisation based on lines extracted from images may be inaccurate during reduced-light conditions. A method for mapping and localisation during low light conditions using light sources is disclosed in patent application EP 17199772.9. Additionally, a method for merging maps comprising visual features extracted during daytime and night-time is disclosed in the aforementioned application.

While the discussed prior art may be satisfactory in some instances, it has certain drawbacks and limitations. In particular, night-time localisation may be more challenging and error-prone, particularly if line-based localisation is used.

### SUMMARY

In light of the above, it is an object of the present invention to overcome or at least alleviate the shortcomings and disadvantages of the prior art. In particular, it is an object of the present invention to improve mapping and localisation, particularly during low light conditions, through the use of a time-of-flight (ToF) sensor.

The present invention is specified in the claims as well as in the below description Preferred embodiments are particularly specified in the dependent claims and the description of various embodiments.

In a first embodiment, the present invention discloses a method for localisation. The method comprises providing at least one ToF sensor, map data and a processing unit. The at least one ToF sensor captures at least one ToF sensor image comprising at least one feature. The processing unit extracts at least one feature from the at least one ToF sensor image. The processing unit compares the at least one extracted feature with the map data. Further the method comprises generating a location hypothesis based on the comparison of the at least one extracted feature with the map data. The location hypothesis can relate to the location on map of the ToF sensor, more particularly, the location on map of the ToF sensor when it captured the ToF sensor image wherein the features were extracted.

That is, the method comprises utilizing at least one ToF sensor for localisation. This is advantageous, as typically ToF sensor can allow for computer vision at reduced light conditions, such as, during night. Hence, the ToF sensor can allow for localisation during reduced light conditions, such as, during night.

Further, method of localisation according to the first embodiment, is based on detecting features of an environment using at least one ToF sensor. The features can comprise visual features, e.g. shapes/patterns or a combination of shapes/patterns that can be distinct on an environment. This can provide a highly accurate localisation, particularly if a plurality of features can be detected on an environment. Feature based localisation, which can be enabled through the use of at least one ToF sensor, are typically associate with high localisation accuracy. This can be advantageous particularly for facilitating the localisation and navigation of mobile robots, particularly autonomous or partly-autonomous mobile robots, e.g. a mobile delivery robot configured to autonomously or partly autonomously deliver at least one item to at least one location.

Further, the ToF sensors can typically operate with infrared light. The infrared light comprises similar wavelengths to visible light. Hence, features of an environment that can be captured by a ToF sensor can be similar to features of an environment that can be captured by a camera (which operate by sensing visible light reflected from surfaces of an environment in their field of view). Hence, localisation using ToF sensors can be combined with localisation using visual cameras. For example, the same map data or similar techniques can be used for both localizations. This can be advantageous, as the utilization of data from multiple sensors may increase the accuracy of localisation. At the same time, the utilization of data from TOF sensors and cameras can be efficiently performed (e.g. using same map data, similar processing techniques, etc.).

In some embodiments, the features that can be captured by a ToF sensor on a ToF sensor image and that can be extracted from a ToF sensor image by the processing unit may comprise straight lines. The straight lines can refer to patterns on a ToF sensor image with a substantially straight-line shape. The straight lines can, for example, belong to stationary objects, such as edges of stationary objects, such as road endings, edges of buildings, edges of signs, signposts, fences, trees, walls.

In some embodiments, the straight lines can be extracted by applying an edge detection algorithm on a ToF sensor image, such as, the Canny edge detection algorithm, that can extract edges from a ToF sensor image. Further, a line extraction algorithm can be applied on the results of the edge detector algorithm for extracting those edges that can comprise a substantially straight line. Alternatively, the line extraction algorithm may be applied directly on the ToF sensor image and can directly extract straight lines from a ToF sensor image. An example of a line detection/extracting algorithm is the Hough transform algorithm. However, any line extracting algorithm can be used for detecting and extracting lines from a ToF sensor image.

It will be noted, that other features in addition or alternative to the straight lines can be used, such features comprising other shapes, such as, curved lines, circles, rectangles, etc. However, the use of straight lines can be more advantageous. Firstly, it can be less complex to detect, extract and/or store straight lines. This can result in less time and computational resources required for detecting and extracting straight lines and in less memory storage required for storing straight lines. Secondly, straight lines can appear frequently in environments (and on images of the environments), such as, on edges of objects, e.g. edges of roads, trees, buildings, etc. Thus, more features (i.e. straight lines) can be extracted from ToF sensor image and as a result the localisation accuracy can be improved.

In some embodiments, the features that can be captured by a ToF sensor on a ToF sensor image and that can be extracted from a ToF sensor image by the processing unit may comprise light sources. The light sources may comprise urban lights, streetlights, lights from illuminated windows, etc.). They can be extracted from a ToF sensor image by recognizing stationary light sources captured on the ToF sensor image. The light sources can appear on a ToF sensor image as blobs. A blob detection algorithm, such a, a brightness thresholding, may be used to detect a light source on a ToF sensor image.

The light sources can be advantageous particularly for localisation at low light conditions, when light sources, such as, urban lights are switched on. Hence, the light sources may allow for visual navigation and localization also at low light conditions, such as, during night.

In some embodiments, the method can comprise the ToF sensor capturing at least one 3D (3-dimensional) ToF sensor image. Each pixel of the 3D ToF sensor image can comprise a distance to a respective object and/or surface on the field of view of the ToF sensor. That is, the 3D ToF sensor image comprises depth information (e.g. based on the content of the pixel) in addition to information indicating the horizontal and vertical position of a portion of the field of view of the ToF sensor (e.g. based on the position of a pixel on the 3D ToF sensor image). Hence, such ToF sensor image can be referred to as 3D ToF sensor images, or distance images. The distance images or 3D ToF sensor images can facilitate measuring distances to objects in the field of view of the ToF sensor.

In some embodiments, the method comprises capturing 3D ToF sensor images that can comprise a width between 100 to 500 pixels, such as, 320 pixels and a height between 100 to 500 pixels, such as 240 pixels. Generally, images with a higher resolution can be advantageous in term of accuracy of results or extended field of view of the ToF sensor. However, larger images can be associated with higher memory space that may be required for storing them, more computational resources for processing them and/or less cost-efficient ToF sensors.

In some method embodiments, the distance to an object and/or surface on the field of view of the ToF sensor can be obtained by emitting a measuring signal comprising infrared light, such as electromagnetic waves with wavelengths between 700-1400 nm, preferably between 750-1050 nm and receiving the measuring signal after the measuring signal is reflected by the surface on the field of view of the ToF sensor and estimating the distance to an object and/or surface in the field of view of the ToF sensor based on at least one of: a time-of-flight of the measuring signal and a difference between the emitted measuring signal and received measuring signal.

That is, the ToF sensor can illuminate the environment, i.e. generate a measuring signal. The illumination or the measuring signal (which can be infrared light) can perform a round trip between the ToF sensor to objects in the environment. A distance to an object or surface in the environment can be calculated or inferred based on the time-of-flight of the measuring signal (i.e. time required for the measuring signal to perform the round trip). Alternatively or additionally, a difference between the emitted measuring signal and received measuring signal can be used for estimating the distance.

Estimating the distance to an object and/or surface in the field of view of the ToF sensor can comprise estimating the distance travelled by the received measuring signal.

The method can comprise a controlling unit estimating the distance to an object and/or surface in the field of view of the ToF sensor. The controlling unit can be part of the ToF sensor. Alternatively, the processing unit can comprise the controlling unit. That is, the controlling unit can be integrated on the processing unit or the functionality of the controlling unit can be carried out by the processing unit. In such embodiments, the method can further comprise sending the ToF sensor measurements to the processing unit.

In some embodiments, the step of emitting a measuring signal can comprise emitting electromagnetic waves with a bandwidth extending between 750-950 nm, preferably with higher signal power between 830-870 nm, such as, with a centroid at 850 nm. Alternatively, the step of emitting a measuring signal can comprise emitting electromagnetic waves with a bandwidth extending between 800-1050 nm, preferably with higher signal power between 930-970 nm, such as, with a centroid at 940 nm.

In some embodiments, the difference between the emitted measuring signal and the received measuring signal can comprise a phase shift of the received measuring signal compared to the emitted measuring signal and the distance to the object and/or surface on the field of view of the ToF sensor can be measured based on the phase shift of the received measuring signal. In such embodiments, it can be advantageous to emit a modulated signal, for example, pulse width modulated signals. This can facilitate detecting a phase (or phase shift) of the measuring signal.

That is, due to the traveling time of the measuring signal, the measuring signal can be received with a different phase then when emitted. The more the distance travelled by the measuring signal the more the phase shift of the measuring signal. Furthermore, if the travelled distance is smaller than the wavelength of the measuring signal, a one-to-one mapping (or relation) can be determined between the phase shift and the distance travelled by the measuring signal. This mapping can be determined based on the wavelength of the measuring signal, phase shift and speed of light in the respective medium of travelling (usually air).

In some embodiments, the difference between the emitted measuring signal and the received measuring signal can comprise an attenuation of the measuring signal and wherein the distance to the object and/or surface on the field of view of the ToF sensor can be measured based on the attenuation of the measuring signal. That is, typically an environment (such as, air) can attenuate the measuring signal (i.e. can reduce its power). The higher the traveling distance the higher the attenuation. A one-to-one mapping (or relation) can be determined for calculating the distance travelled by the measuring signal based on the difference between the emitted and received power of the measuring signal (i.e. attenuation). This can be advantageous as it the measured distance may not suffer from ambiguity.

In some embodiments, the step of emitting the measuring signal can comprise an illumination unit, such as a laser diode or a light emitting diode, emitting the measuring signal. The ToF sensor can comprise the illumination unit.

In some embodiments, the step of receiving the measuring signal can comprise an imaging sensor sensing the measuring signal comprising infrared light, such as electromagnetic waves with wavelengths between 700-1400 nm, preferably between 750-1050 nm.

In some embodiments, the ToF sensor can comprise the imaging sensor and preferably the illumination unit.

In some embodiments, the imaging sensor can comprise a plurality of photo-sensitive elements, such as, 100 to 500 rows of photo-sensitive elements wherein each row comprises 100 to 500 of photo-sensitive elements. The photo-sensitive elements can sense infrared light, such as electromagnetic waves with wavelengths between 700-1400 nm, preferably between 750-1050 nm. The output of each photo-sensitive element can be used to determine the value of a corresponding pixel on the ToF sensor image. For example, the phase shift can be calculated for the signal received by each photo-sensitive element and a respective distance can be further calculated. The respective distance can be provided on a respective pixel of the 3D ToF sensor image.

In some embodiments, the measuring signal can be a modulated signal. An amplitude modulation scheme, e.g., a pulse width modulation scheme may be used for modulating the measuring signal, before emitting it. The measuring signal can be modulated on a carrier wave. The carrier wave can comprise a frequency of 1 to 100 MHz, such as, 5 to 30 MHz, preferably 10 to 20 MHz. In some embodiments, wherein a controlling unit is provided, the step of modulating the measuring signal can be carried out by the controlling unit.

In some embodiments, the method comprises extracting straight lines from a 3D ToF sensor image. The straight lines can be extracted from a 3D ToF sensor image by detecting a plurality of interfacing points between two adjacent pixels of the 3D ToF sensor image wherein the difference between the distance values of the two adjacent pixels can be larger than a predetermined distance threshold value and wherein the interfacing points can be arranged in substantially straight lines pattern.

The predetermined distance threshold value can be between, 0.5 cm to 10 cm, such as 1 cm. The predetermined threshold value can also depend on the noise of the ToF sensor measurements. That is, the predetermined threshold value can preferably be equal or larger than the random noise that can be experienced during the distance measurement by the ToF sensor.

In some embodiments, light sources can be detected and extracted from a 3D ToF sensor image. The light sources can appear on a 3D ToF sensor image with a distance of zero (or very small distance) as their light can immediately be received by the ToF sensor, making the ToF sensor infer a distance of “zero” travelled by the incoming light. Alternatively, in embodiments wherein modulated light can be emitted and used for measuring distance, the light arriving from the light sources can be filtered. As a result, pixels wherein the light sources would normally appear on the 3D ToF sensor image, can be “blank”, e.g. without distance information (e.g. NULL value). Either way, the light sources can appear on a 3D ToF sensor image as blobs. Using a blob detection algorithm, the light sources can be extracted from a 3D ToF sensor image.

In some embodiments, the method can comprise the ToF sensor capturing at least one 2D ToF sensor image. The 2D ToF sensor image can be a grayscale image. That is, in contrast to the 3D ToF sensor images, the 2D ToF sensor images do not comprise depth information. More particularly, the 2D ToF sensor images can comprise intensity or brightness information.

In some embodiments, the method can comprise capturing 2D ToF sensor images that can comprise a width between 100 to 500 pixels, such as, 320 pixels and a height between 100 to 500 pixels, such as 240 pixels.

In some embodiments, the method can comprise capturing the 2D ToF sensor image by emitting active illumination comprising infrared light, such as electromagnetic waves with wavelengths between 700-1400 nm, preferably 750-1050 nm and receiving the emitted illumination after being reflected by the surface on the field of view of the ToF sensor and measuring the intensity of the received illumination. The measured intensity can be mapped to a grayscale (i.e. different shades of grey color, or any other color) for generating a grayscale image.

The step of emitting active illumination for capturing a 2D ToF sensor image can comprise an illumination unit, such as a laser diode or a light emitting diode, emitting infrared light such as electromagnetic waves with wavelengths between 700-1400 nm, preferably 750-1050 nm. Further, the step of receiving the emitted illumination can comprise an imaging sensor sensing infrared light, such as electromagnetic waves with wavelengths between 700-1400 nm, more preferably 750-1050 nm. The ToF sensor can comprise the imaging sensor and preferably the illumination unit.

In some embodiments, the step of capturing at least one 2D ToF sensor image can comprise receiving light, such as visible light and/or infrared light from an external light source, such as, the sunlight and/or urban lights.

In some embodiments, the method comprises extracting straight lines from a 2D ToF sensor image. The straight lines can be extracted from a 2D ToF sensor image by detecting a plurality of interfacing points between two adjacent pixels of the 2D ToF sensor image wherein the difference between the intensity values of the two adjacent pixels is larger than a predetermined intensity threshold value and wherein the interfacing points are arranged in substantially straight lines pattern. The predetermined intensity threshold value can vary depending on the image (e.g. depending on light conditions the image is captured). The intensity threshold value can be set by an optimization algorithm that can determine an intensity threshold value that can yield the highest number of detected straight lines.

The light sources, which can generally emit light with high intensity, can appear on a 2D ToF sensor images as bright spots. As such, they can be extracted from a 2D ToF sensor image by detecting bright spots on the 2D ToF sensor image, for example, using brightness thresholding.

As discussed, the method for localisation according to the first embodiment, comprises the processing unit comparing the at least one extracted feature (from at least one ToF sensor image) with the map data. In some embodiments, this step can comprise finding an intersection set of features of the at least one extracted feature and the map data, wherein the intersection set of features comprises features that are extracted from the at least one ToF sensor image and are mapped on the map.

That is, the map data can comprise a representation of an environment, such as, roads, buildings, houses, doors of houses (or entrance points), etc. In addition, the map data can comprise features. These features may be straight lines (e.g. edges of buildings, roads, etc.) and/or light sources (e.g. streetlights, illuminated windows of buildings, etc.). Thus, in some embodiments the method comprises extracting at least one feature from a ToF sensor image that can correspond to a mapped feature (i.e. feature on the map). For example, an extracted straight line corresponding to an edge of a building can already be comprised in the map as a feature (i.e. straight line) that corresponds to the same edge of the same building and the intersection set of features can comprise the said straight line in the example.

The location hypothesis can be generated based on the known position on the map of the features comprised in the intersection set of features and the relative position between ToF sensor and the location of the features comprised in the intersection set of features. That is, map data can comprise feature, which can be referred to as mapped features, and the location of the mapped featured on the map can be known. By matching a corresponding mapped feature to the extracted feature, the location of the extracted feature can be determined. Furthermore, the relative location between the extracted feature and the ToF sensor can be known (e.g. based on a calibration step of the ToF sensor or on a distance measurement of the ToF sensor). Based on the determined location of at least one extracted feature and the relative location between the ToF sensor and the at least one extracted feature the location hypothesis can be generated. The location hypothesis can relate to the location on map of the ToF sensor, more particularly, the location on map of the ToF sensor when it captured the ToF sensor image wherein the features were extracted.

In some embodiments, the method can comprise utilizing at least one further sensor for generating the location hypothesis, such as at least one of a GPS sensor, odometer, gyroscope, accelerometer, inertial measurement unit.

In some embodiments, the relative complement set of features of the map data in the at least one extracted feature can be added to the map based on the generated location hypothesis, wherein the said relative complement set of features comprises features that are extracted from the at least one ToF sensor image but are not mapped in the map. The relative complement set of features of the map data in the at least one extracted feature can also be termed as the set difference of the at least one extracted feature and the map data. That is, if we can denote the set of features comprised in the map data as [symbol] and the set comprising the at least one extracted feature as ε, then the relative complement of the map data in the at least one extracted feature, i.e. the relative complement of [symbol] in ε, denoted as ε\ [symbol] can be defined as:

$$ℰ ∖ = \{ x ∈ ℰ \vert x ∉ \} ,$$

wherein x generally denotes an element of a set.

In other words, features that can be extracted from a ToF sensor image but that are not already mapped (which can be referred to as unmapped features) can be added to the map data. To add the unmapped features on the map the location of the unmapped features on the map is required, that is, the relative location between the unmapped feature and at least one feature on the map may be required. Hence, the unmapped features can be added to the map after the location hypothesis (of the location wherein the ToF sensor image comprising said features is captured) is generated. The location hypothesis can facilitate the determination of the location of the unmapped features on the map. Thus, embodiments of the present technology may allow for extending the map data with further features.

When the intersection set of features can be an empty set (that is, no corresponding mapped features can be found for the extracted features) the location hypothesis can be by utilizing at least one of: a GPS sensor, odometer, gyroscope, accelerometer, inertial measurement unit. In such embodiments, an operator may further provide an input to improve the location hypothesis. Based on the location hypothesis the extracted features can be added to the map.

In some embodiments, the method can further comprise providing at least one visual camera configured to capture at least one visual image comprising features. The visual camera can be configured to sense visual light (e.g. electromagnetic waves with wavelengths between 380-740 nm). The visual camera can be configured to extract color information from an environment and output a visual image comprising the color information of the environment.

The method can further comprise the processing unit extracting at least one feature from the at least one visual image captured by the at least one camera.

The features that can be extracted from the visual images can comprise at least one of: straight lines and light sources. Due to the similarity of the wavelengths of the light that can be sensed by the ToF sensor and the visual camera, the features that can be extracted from the ToF sensor image can be similar to the features that can be extracted from a ToF sensor image. For example, a straight line from an edge of a building can be extracted from a ToF sensor image and a visual image capturing the said edge of the building.

The straight lines can be extracted from the at least one visual image by utilizing at least one of: edge detector algorithm, such as, the Canny edge detector algorithm, and a line extraction algorithm, such as, the Hough transform algorithm. In some embodiments, the line extraction algorithm can be performed on the output of the edge detection algorithm. That is, the line extraction algorithm can extract edges that comprise a substantially straight-line shape. Alternatively, the line extraction algorithm can be directly applied on visual images for extracting patterns on the image with a substantially straight-line shape. In general, the former method (i.e. applying the line extraction algorithm on top of the edge detection algorithm) can provide more accurate results.

The light sources can be extracted from the at least one visual image by utilizing a brightness thresholding algorithm or blob detection algorithm. That is, the light sources (when switched on) generally appear on a visual image as blobs, such as, bright spots—i.e. regions on an image with similar properties (such as, brightness or color) which properties differ with the surrounding region. A blob detection algorithm, e.g. brightness thresholding, can be used for detecting such bright spots on the image that can correspond to light sources.

In some embodiments, the method can comprise extracting a first set of features from at least one ToF sensor image and a second set of features at least one visual image. That is, at least one ToF sensor and at least one camera can be used for capturing images. The images of the respective sensor can be processed for extracting at least one feature. In other words, the localisation method can utilize at least one ToF sensor and at least one camera.

In such embodiments, the location hypothesis can be generated based on the first set of features and the second set of features. More particularly, the location hypothesis can be generated based on a comparison of the first set of features with the map data and a comparison of the second set of features on the map data.

This can further be facilitated by the similarity between the features that can be extracted from a ToF sensor image and the features that can be extracted from a camera. For example, the features can used for localisation irrespective from which sensor image they were extracted from. The map data may comprise features without the need of labeling the features as being related to features that can be extracted from a ToF sensor image or features that can be extracted from a camera. In other words, the same map data can be used. Further still, the first set of features and the second set of features may complement each other. That is, they can be merged on a larger set comprising features from the first set of features and features from the second set of features. This can further improve the accuracy of the location hypothesis.

The first set of features can be used to calibrate the at least one visual camera and the second set of features can be used to calibrate the at least one ToF sensor. During this calibration the relative position between the stereo cameras and the ToF sensors can be obtained. A common reference system can be generated. The common reference system can be used by the stereo cameras and the ToF sensors. The positioning of the stereo cameras and the ToF sensors on the common reference system can be known. During the determination of the position of at least one feature, the stereo cameras and the ToF sensors may determine the position of the feature according to the common reference system. Thus, if the position of a feature is determined by the stereo cameras in terms of the common reference system, the ToF sensor can accurately obtain the position of the feature and vice versa.

In some embodiments, the method can comprise providing a daytime map and a night-time map. The daytime map can comprise daytime features dominantly comprising straight lines. That is, the daytime features can comprise features that can be extracted from a ToF sensor image (and/or visual image) during daytime. As during daytime, the light sources are generally switched off, the daytime features comprised in the daytime map dominantly comprise straight lines. The night-time map can comprise night-time features dominantly comprising light sources. That is, the night-time map can comprise features that can be extracted from a ToF sensor image (and/or visual image) during low-light conditions. The night-time feature may be dominated by light sources as they are generally switched on during nighttime and can be easily visible.

Note that the daytime features may comprise light sources too, though their number may be small, or at least smaller than the number of straight lines comprised in the daytime map. Similarly, the night-time features may comprise straight lines too, though their number may be small, or at least smaller than the number of light sources comprised in the night-time map. As such, the daytime map can be more efficient when used during daytime (i.e. good light conditions) and the night-time map can be more efficient when used during night-time (i.e. low light conditions).

However, comprising two maps for daytime and nigh-time may not be very efficient, for example, in terms of memory use. For example, at least information regarding the location of roads and buildings would have to be stored two times—i.e. in both maps, which may need more memory storage.

To alleviate this drawback of comprising two maps, in some embodiments the method can comprise merging the daytime map and the night-time map into a single map by determining the relative position between daytime features and the night-time features. That is, a map generally consists of elements on the map wherein the relative location of the elements on the map is known. Thus, by determining the relative position between the daytime features comprised in the daytime map and the night-time features comprised in the night-time map, the two maps can be merged into one.

The method can comprise determining the relative position between daytime features and the night-time features based on the relative position between the extracted features from a ToF sensor image. Preferably, the ToF sensor image can be captured at reduced light conditions, such as, during night-time, more particularly, when the light sources can be switched on. Further, the ToF sensor image can further be captured using active illumination—i.e. an illumination unit can be used to illuminate the captured environment with infrared light. Thus, though visible light may be very low, as the ToF sensor can sense infrared light (i.e. not visible light), the environment may be illuminated for the ToF sensor (e.g. by active illumination). Thus, the ToF sensor may capture straight lines efficiently, which otherwise using a visual image would be barely visible, and light sources which can be switched on and easily visible (particularly at low light conditions). The extracted straight lines can be matched with corresponding daytime features on the night-time map. The extracted light sources can be matched with corresponding night-time features on the night-time map. As the relative location between the extracted straight lines and extracted light sources can be determined (because they are extracted from same ToF sensor image) this may allow the relative location between daytime features and night-time features to be determined. Thus, the two maps can be merged. Note that, the method can also comprise generating a new map comprising night-time features and daytime features by adding the features extracted from a ToF sensor image on a map (e.g. map of roads and buildings).

More particularly, the method can comprise determining a third intersection set of features between the extracted features from a ToF sensor image and daytime features comprised in the daytime map and a fourth intersection set of features between the extracted features from a ToF sensor image and night-time features comprised in the night-time map.

The relative position between the third intersection set of features and the fourth intersection set of features can be inferred based on the position of the extracted features on a ToF sensor image.

The relative position between the third intersection set of features and the fourth intersection set of features can be used to align the daytime features comprised in the daytime map and the night-time features comprised in the night-time map. This can allow the merging of the two maps.

In some embodiments, the method can comprise providing a mobile robot that comprises the at least one ToF sensor.

In such embodiments, the method can further comprise determining the location of the mobile robot on the map based on the generated location hypothesis.

The step of providing the processing unit can comprise providing processing unit internal to the mobile robot. Alternatively, the method can comprise providing the processing unit external to the mobile robot, such as a server external to the mobile robot and the mobile robot and the server can transfer data between each other, preferably remotely.

In a second embodiment a localisation system is disclosed. The localisation system comprises at least one time-of-flight (ToF) sensor configured to capture at least one ToF sensor image and a memory unit, comprising stored therein map data and a processing unit. The processing unit is configured to extract at least one feature from the at least one ToF sensor image. Further the processing unit is configured to access the memory unit comprising the map data and compare the at least one extracted feature with the map data. Further the processing unit is configured to generate a location hypothesis based on the comparison of the at least one extracted feature with the map data.

The ToF sensor can comprise at least one illumination unit, such as, a laser diode or light emitting diode. The illumination unit can be configured to emit infrared light, such as electromagnetic waves with wavelengths between 700-1400 nm, preferably between 750-1050 nm.

In some system embodiments, the illumination unit can be configured to emit light with wavelengths of 750-950 nm, preferably with maximum emission power at wavelengths between 830-870 nm, such as with a centroid wavelength of 850 nm. Alternatively, the illumination unit can be configured to emit light with wavelengths of 800-1050 nm, preferably with maximum emission power at wavelengths between 930-970 nm, such as with a centroid wavelength of 940 nm.

The illumination unit can be configured to emit a modulated signal. The carrier wave that can be used for the modulation can comprise a frequency of 1 to 100 MHz, such as, to 30 MHz, preferably 10 to 20 MHz. The use of modulated signal can be advantageous as it can make the ToF sensor more robust to noise, e.g. the external light sources, such as, sunlight, urban lights, etc., can be more easily extracted or filtered. Furthermore, the use of modulated light can allow for performing distance measurements with the ToF sensor based on the phase of the modulated signal when transmitted and received. The determination of distance travelled by a received signal based on its phase shift can provide accurate distance measurements.

The ToF sensor can comprise a modulation unit configured to modulate the carrier wave with infrared light such as an electromagnetic wave with wavelength between 700-1400 nm, even more preferably 750-1050 nm.

The modulated light can be modulated using an amplitude modulation scheme, such as, pulse width modulation.

The ToF sensor can comprise an imaging sensor that can be configured to be sensitive to infrared light, such as electromagnetic waves with wavelengths between 700-1400 nm, preferably 750-1050 nm.

The imaging sensor can comprise a plurality of photo sensitive elements configured to sense infrared light, such as, near infrared light, preferably electromagnetic waves with wavelengths between 700-1400 nm, more preferably 750-1050 nm.

The photo sensitive elements can be arranged as a sensor array, that is, in a certain geometric pattern, such as, as rows stacked one above the other forming a “matrix” of photo sensitive elements. The imaging sensor can comprise 100 to 500 rows of photo-sensitive elements, such as, 240 rows and wherein each row comprises 100 to 500 of photo-sensitive elements, such as, 340 photo-sensitive elements.

The photosensitive elements can be configured to convert incoming light into electric current and store the induced electric charge in an electric charge storage element, such as, a capacitor. That is the “sensed information” can be stored in a capacitor while the imaging unit senses. The information stored in the capacitor (i.e. the amount of induced charge) can be further used for generating ToF sensor images.

The ToF sensor can further comprise a control unit configured to facilitate the operation of the ToF sensor. For example, the ToF sensor unit can be configured to trigger the activation of the illumination unit and/or trigger the imaging unit to sense and/or read the information stored in the capacitors of the respective photosensitive elements and/or generate and output the ToF sensor image.

In some embodiments, the control unit can comprise the modulation unit.

The ToF sensor can comprise an optical element comprising an optical lens configured to collect the incoming light and focuses it onto the imaging sensor. That is, generally the imaging sensor comprises a small area. Hence, it can sense light from small portion of the environment. However, the optical lens can be configured to receive light from an extended range of directions as compared to the imaging sensor and focus the received light onto the imaging sensor. Thus, the imaging sensor with the optical lens can receive light from multiple directions and the field of view of the ToF sensor can be extended.

The optical element can comprise an optical filter configured as a bandpass optical filter, that can allow only electromagnetic waves within a certain band of frequencies, such as, infrared light, preferably electromagnetic waves with wavelengths between 700-1400 nm, even more preferably 750-1050 nm to pass through while suppressing the other electromagnetic waves. Hence noise from external light sources, such as, sunlight or light from urban lights, can be filtered. This can result in better accuracy of measurements by the The mobile robot can be configured for land-based motion. The mobile robot can be a delivery robot, such as, a delivery robot configured for last-mile item delivery.

The mobile robot can be a fully or partially autonomous mobile robot. This can allow the task of item delivery for example, to be fully or partially automated.

The mobile robot can comprise the at least one ToF sensor. The mobile robot can comprise at least one front ToF sensor mounted on a front side of the mobile robot. Alternatively or additionally, the mobile robot can comprise at least one side ToF sensor mounted on at least one of the sides of the mobile robot, preferably at least two side ToF sensors mounted on the sides of the mobile robot. The mobile robot can comprise the at least one ToF sensor mounted at a height from the ground of 10-70 cm, preferably 20-55 cm, more preferably 40-50 cm.

The mobile robot can comprise the processing unit.

The mobile robot can comprise the memory unit. Hence, the robot can comprise the map data in an internal memory unit. Alternatively, the mobile robot may be configured to download the map data from an external storage.

The mobile robot can further comprise at least one visual camera, preferably, at least one visual stereo camera.

The mobile robot can comprise at least one of: a GPS sensor, odometer, gyroscope, accelerometer, inertial measurement unit.

The system can further comprise a server.

The mobile robot and the server can be configured for communication, preferably bidirectional communication.

In some embodiments, the server can comprise the processing unit.

In some embodiments, the server can comprise the memory unit.

The system can be configured to carry out the method according to any of the preceding method embodiments. More particularly, the system can be configured to carry out the method according to any of the preceding method embodiments to localise the mobile robot.

Below further numbered embodiments of the invention will be discussed.

Below, method embodiments will be discussed. These embodiments are abbreviated by the letter “M” followed by a number. Whenever reference is herein made to “method embodiments”, these embodiments are meant.
M1. A method for localisation comprising
   (a) providing at least one ToF sensor (10), map data and a processing unit;
   (b) the at least one ToF sensor (10) capturing at least one ToF sensor image comprising at least one feature (30, 32);
   (c) the processing unit extracting at least one feature (30, 32) from the at least one ToF sensor image;
   (d) the processing unit comparing the at least one extracted feature (30, 32) with the map data; and
   (e) generating a location hypothesis based on the comparison in step (d).

### —Types of Feature—

M2. A method according to the preceding embodiment, wherein step (c) comprises extracting straight lines (30).
M3. A method according to the preceding embodiment, wherein extracting straight lines (30) from a ToF sensor image comprises recognizing patterns on the ToF sensor image that have a shape of a substantially straight line.
M4. A method according to any of the 2 preceding embodiments, wherein the processing unit carries out an edge detection algorithm, such as the Canny edge detector algorithm, for extracting edges from a ToF sensor image.
M5. A method according to any of the 3 preceding embodiments, wherein the processing unit carries out a line extracting algorithm, such as the Hough transform algorithm, for extracting straight lines (30) from a ToF sensor image.
M6. A method according to the 2 preceding embodiments, wherein the line extracting algorithm is applied on the results of the edge detector algorithm.
M7. A method according to any of the 5 preceding embodiments, wherein the straight lines (30), belong to stationary objects, such as edges of stationary objects, such as road endings, edges of buildings, edges of signs, signposts, fences, trees, walls.
M8. A method according to any of the preceding embodiments, wherein step (c) comprises extracting light sources (32) from a ToF sensor image.
M9. A method according to the preceding embodiment, wherein light sources (32) are extracted from a ToF sensor image by recognizing stationary light sources captured on the ToF sensor image.
M10. A method according to any of the 2 preceding embodiments, wherein the processing unit carries out a brightness thresholding algorithm for extracting light sources (32) from a ToF sensor image.

### —3D ToF Sensor Image—

M11. A method according to any of the preceding embodiments, wherein step (b) comprises capturing at least one 3D ToF sensor image, wherein each pixel of the 3D ToF sensor image comprises a distance to a respective object and/or surface on the field of view of the ToF sensor (10).
M12. A method according to the preceding embodiment, wherein the 3D ToF sensor image comprises a width between 100 to 500 pixels, such as, 320 pixels and a height between 100 to 500 pixels, such as 240 pixels.
M13. A method according to any of the 2 preceding embodiments, wherein the distance to an object and/or surface on the field of view of the ToF sensor (10) is obtained by
   emitting a measuring signal comprising infrared light, such as electromagnetic waves with wavelengths between 700-1400 nm, preferably between 750-1050 nm and
   receiving the measuring signal after the measuring signal is reflected by the surface on the field of view of the ToF sensor (10) and
   estimating the distance to an object and/or surface in the field of view of the ToF sensor (10) based on at least one of: a time-of-flight of the measuring signal and a difference between the emitted measuring signal and received measuring signal.
M14. A method according to the preceding embodiment, wherein estimation of the distance to an object and/or surface in the field of view of the ToF sensor (10) comprises estimating the distance travelled by the received measuring signal.
M15. A method according to any of the 2 preceding embodiments, wherein estimation of the distance to an object and/or surface in the field of view of the ToF sensor (10) is performed by a controlling unit (1).
M16. A method according to the preceding embodiment, wherein the controlling unit (1) is part of the ToF sensor (10)
M17. A method according to the penultimate embodiment, wherein the processing unit comprises the controlling unit (1).
M18. A method according to any of the 5 preceding embodiments, wherein the step of emitting a measuring signal comprises emitting electromagnetic waves with a bandwidth extending between 750-950 nm, preferably with higher signal power between 830-870 nm, such as, with a centroid at 850 nm.
M19. A method according to any of embodiment M13 to M17, wherein the step of emitting a measuring signal comprises emitting electromagnetic waves with a bandwidth extending between 800-1050 nm, preferably with higher signal power between 930-970 nm, such as, with a centroid at 940 nm.
M20. A method according to any of the 7 preceding embodiments, wherein the difference between the emitted measuring signal and the received measuring signal comprises a phase shift of the received measuring signal compared to the emitted measuring signal and the distance to the object and/or surface on the field of view of the ToF sensor (10) is measured based on the phase shift of the received measuring signal.
M21. A method according to any of the 8 preceding embodiments, wherein the difference between the emitted measuring signal and the received measuring signal comprises an attenuation of the measuring signal and wherein distance to the object and/or surface on the field of view of the ToF sensor (10) is measured based on the attenuation of the measuring signal.
M22. A method according to any of the 9 preceding embodiments, wherein the step of emitting the measuring signal comprises an illumination unit (3), such as a laser diode (3) or a light emitting diode (3), emitting the measuring signal.
M23. A method according to any of the 10 preceding embodiments, wherein the step of receiving the measuring signal comprises an imaging sensor (5) sensing the measuring signal comprising infrared light, such as electromagnetic waves with wavelengths between 700-1400 nm, preferably between 750-1050 nm.
M24. A method according to the 2 preceding embodiments wherein the ToF sensor (10) comprises the imaging sensor (5) and preferably the illumination unit (3).
M25. A method according to the preceding embodiment, wherein the imaging sensor (5) comprises a plurality of photo-sensitive elements (50), such as, 100 to 500 rows of photo-sensitive elements (50) wherein each row comprises 100 to 500 of photo-sensitive elements (50) and wherein the photo-sensitive elements (50) sense infrared light, such as electromagnetic waves with wavelengths between 700-1400 nm, preferably between 750-1050 nm and wherein the output of each photo-sensitive element (50) is used to determine the value of a corresponding pixel on the ToF sensor image.
M26. A method according to any of the 13 preceding embodiments wherein the measuring signal is a modulated signal.
M27. A method according to the preceding embodiment, wherein the measuring signal is an amplitude modulated signal, such as, a pulse width modulated signal.
M28. A method according to any of the 2 preceding embodiments, wherein a carrier wave is used for the modulation of the measuring signal and the carrier wave comprises a frequency of 1 to 100 MHz, such as, 5 to 30 MHz, preferably 10 to 20 MHz.
M29. A method according to any of the 3 preceding embodiments and with the features of embodiment M15, wherein the step of modulating the measuring signal is carried out by the controlling unit (1).
   —Extracting Features from 3D ToF Sensor Image—
M30. A method according to any of the preceding embodiments and with the features of embodiments M2 and M11, wherein the straight lines (30) are extracted from a 3D ToF sensor image by
   detecting a plurality of interfacing points between two adjacent pixels of the 3D ToF sensor image wherein the difference between the distance values of the two adjacent pixels is larger than a predetermined distance threshold value and
   wherein the interfacing points are arranged in substantially straight lines pattern.
M31. A method according to the previous embodiment, wherein the predetermined distance threshold value is between 0.5 cm to 10 cm, such as 1 cm.
M32. A method according to any of the preceding embodiments and with the features of embodiments M8 and M11, wherein light sources (32) are detected using a blob detection algorithm.

### —2D ToF Sensor Image—

M33. A method according to any of the preceding embodiments, wherein step (b) comprises capturing at least one 2D ToF sensor image.
M34. A method according to the preceding embodiment, wherein the 2D ToF sensor image is a grayscale image.
M35. A method according to any of the 2 preceding embodiments, wherein the 2D ToF sensor image comprises a width between 100 to 500 pixels, such as, 320 pixels and a height between 100 to 500 pixels, such as 240 pixels.
M36. A method according to any of the 3 preceding embodiments, wherein capturing the 2D ToF sensor image comprises emitting active illumination comprising infrared light, such as electromagnetic waves with wavelengths between 700-1400 nm, preferably 750-1050 nm and receiving the emitted illumination after being reflected by the surface on the field of view of the ToF sensor (10) and measuring the intensity of the received illumination.
M37. A method according to the preceding embodiment, wherein the step of emitting active illumination comprises an illumination unit (3), such as a laser diode (3) or a light emitting diode (3), emitting infrared light such as electromagnetic waves with wavelengths between 700-1400 nm, preferably 750-1050 nm.
M38. A method according to any of the 2 preceding embodiments, wherein the step of receiving the emitted illumination comprises an imaging sensor (5) sensing infrared light, such as electromagnetic waves with wavelengths between 700-1400 nm, more preferably 750-1050 nm.
M39. A method according to the two preceding embodiments, wherein the ToF sensor (10) comprises the imaging sensor (5) and preferably the illumination unit (3).
M40. A method according to any of the 5 preceding embodiments, wherein the step of capturing at least one 2D ToF sensor image comprises receiving light, such as visible light and/or infrared light from an external light source, such as, the sunlight and/or urban lights.
   —Extracting Features from 2D ToF Sensor Image—
M41. A method according to any of the preceding embodiments and with the features of embodiments M2 and M33, wherein the straight lines (30) are extracted from a 2D ToF sensor image by
   detecting a plurality of interfacing points between two adjacent pixels of the 2D ToF sensor image wherein the difference between the intensity values of the two adjacent pixels is larger than a predetermined intensity threshold value and
   wherein the interfacing points are arranged in substantially straight lines pattern.
M42. A method according to the previous embodiment, wherein the predetermined intensity threshold value varies depending on the image.
M43. A method according to any of the preceding embodiments and with the features of embodiments M8 and M25, wherein light sources (32) are extracted from a 2D ToF sensor image by detecting bright spots on the 2D ToF sensor image.

### —Localisation and Mapping—

M44. A method according to any of the preceding embodiments, wherein step (d) comprises finding an intersection set of features of the at least one extracted feature (30, 32) and the map data, wherein the intersection set of features comprises features (30, 32) that are extracted from the at least one ToF sensor image and are mapped on the map.
M45. A method according to the preceding embodiment, wherein the location hypothesis in step (e) is generated based on the known position on the map of the features (30, 32) comprised in the intersection set of features and the relative position between ToF sensor (10) and the location of the features (30, 32) comprised in the intersection set of features.
M46. A method according to the preceding embodiment, wherein determining the relative position between ToF sensor (10) and the location of the features (30, 32) comprised in the intersection set of features is facilitated by a calibration of the ToF sensor (10).
M47. A method according to any of the 2 preceding embodiments, wherein the location hypothesis in step (e) is generated by further utilizing at least one of: a GPS sensor, odometer, gyroscope, accelerometer, inertial measurement unit.
M48. A method according to any of the 3 preceding embodiments, wherein the relative complement set of features of the map data in the at least one extracted feature (30, 32) is added to the map based on the location hypothesis generated in step (e), wherein the said relative complement set of features comprises features (30, 32) that are extracted from the at least one ToF sensor image but are not mapped in the map.
M49. A method according to embodiment M27, wherein the intersection set of features is an empty set and the location hypothesis in step (e) is generated by utilizing at least one of: a GPS sensor, odometer, gyroscope, accelerometer, inertial measurement unit.
M50. A method according to the preceding embodiment, wherein the method further comprises adding the extracted features (30, 32) on the map based on the location hypothesis generated in step (e).

### —Visual Camera—

M51. A method according to any of the preceding embodiment, further comprising providing at least one visual camera configured to capture at least one visual image comprising features (30, 32).
M52. A method according to the preceding embodiment, wherein the processing unit extracts the features (30, 32) from the at least one visual image.
M53. A method according to any of the 2 preceding embodiments, wherein the features (30, 32) comprise at least one of: straight lines (30) and light sources (32).
M54. A method according to the preceding embodiment, wherein the straight lines (30) are extracted from the at least one visual image by utilizing at least one of: edge detector algorithm, such as, the Canny edge detector algorithm, and a line extraction algorithm, such as, the Hough transform algorithm and wherein the light sources (32) are extracted from the at least one visual image by utilizing a brightness thresholding algorithm.
M55. A method according to the any of the 4 preceding embodiments, wherein a first set of features is extracted from at least one ToF sensor image and a second set of features is extracted from at least one visual image.
M56. A method according to the preceding embodiment, wherein location hypothesis in step (e) is generated based on the first set of features and the second set of features.
M57. A method according to any of the 2 preceding embodiments, wherein the first set of features is used to calibrate the at least one visual camera and the second set of features is used to calibrate the at least one ToF sensor (10).
   —Merging maps—
M58. A method according to any of the previous embodiments, further comprising providing a daytime map and a night-time map, wherein the daytime map comprises daytime features dominantly comprising straight lines (30) and the night-time map comprises night-time features dominantly comprising light sources (32).
M59. A method according to the preceding embodiment, the method comprising merging the daytime map and the night-time map into a single map by determining the relative position between daytime features and the night-time features.
M60. A method according to the preceding embodiment wherein the relative position between daytime features and the night-time features is determined based on the relative position between the extracted features (30, 32) from a ToF sensor image.
M61. A method according to the preceding embodiment, the method further comprises determining a third intersection set of features between the extracted features (30, 32) from a ToF sensor image and daytime features comprised in the daytime map and a fourth intersection set of features between the extracted features (30, 32) from a ToF sensor image and night-time features comprised in the night-time map.
M62. A method according to the previous embodiment, wherein the relative position between the third intersection set of features and the fourth intersection set of features is inferred based on the position of the extracted features (30, 32) on a ToF sensor image.
M63. A method according to the previous embodiment, wherein the relative position between the third intersection set of features and the fourth intersection set of features is used to align the daytime features comprised in the daytime map and the night-time features comprised in the night-time map.

### —Robot—

M64. A method according to any of the preceding embodiments, wherein a mobile robot (20) comprises the at least one ToF sensor (10).
M65. A method according to the preceding embodiments, wherein the location of the mobile robot (20) is generated based on the location hypothesis generated at step (e).
M66. A method according to any of the two preceding embodiments, wherein the mobile robot (20) comprises the processing unit.
M67. A method according to at least one of embodiments M54 and M55, wherein the processing unit is external to the mobile robot (20), such as a server external to the mobile robot (20) and the mobile robot (20) and the server transfer data between each other, preferably remotely.

Below, system embodiments will be discussed. These embodiments are abbreviated by the letter “S” followed by a number. Whenever reference is herein made to “system embodiments”, these embodiments are meant.
S1. A localisation system comprising:
   at least one time-of-flight (ToF) sensor (10) configured to capture at least one ToF sensor image;
   a memory unit, comprising stored therein map data;
   a processing unit configured to
      extract at least one feature (30, 32) from the at least one ToF sensor image and
      access the memory unit comprising the map data and compare the at least one extracted feature (30, 32) with the map data and
      generate a location hypothesis based on the comparison of the at least one extracted feature (30, 32) with the map data.

### —Illumination Unit—

S2. A system according to the preceding system embodiment, wherein the ToF sensor (10) comprises at least one illumination unit (3), such as, a laser diode (3) or light emitting diode (3).
S3. A system according to any of the previous system embodiments, wherein the illumination unit (3) is configured to emit infrared light, such as electromagnetic waves with wavelengths between 700-1400 nm, preferably between 750-1050 nm.
S4. A system according to embodiment S2, wherein the illumination unit (3) is configured to emit light with wavelengths of 750-950 nm, preferably with maximum emission power at wavelengths between 830-870 nm, such as with a centroid wavelength of 850 nm.
S5. A system according to embodiment S2, wherein the illumination unit (3) is configured to emit light with wavelengths of 800-1050 nm, preferably with maximum emission power at wavelengths between 930-970 nm, such as with a centroid wavelength of 940 nm.
S6. A system according to any of the previous system embodiment, wherein the illumination unit (3) is configured to emit a modulated signal and a carrier wave is used for the modulation and the carrier wave comprises a frequency of 1 to 100 MHZ, such as, to 30 MHz, preferably 10 to 20 MHz.
S7. A system according to the preceding embodiment, wherein the ToF sensor (10) comprises a modulation unit configured to modulate the carrier wave with infrared light such as an electromagnetic wave with wavelength between 700-1400 nm, even more preferably 750-1050 nm.
S8. A system according to any of the 2 preceding embodiments, wherein amplitude modulation is used.

### —Imaging Unit—

S9. A system according to any of the preceding system embodiments, wherein the ToF sensor (10) comprises an imaging sensor (5) configured to be sensitive to infrared light, such as electromagnetic waves with wavelengths between 700-1400 nm, preferably 750-1050 nm.
S10. A system according to the preceding system embodiment, wherein the imaging sensor (5) comprises a plurality of photo sensitive elements (50) configured to sense infrared light, such as, near infrared light, preferably electromagnetic waves with wavelengths between 700-1400 nm, more preferably 750-1050 nm.
S11. A system according to the preceding system embodiment, wherein the photo sensitive elements (50) are arranged as a sensor array, that is, in a certain geometric pattern, such as, as rows stacked one above the other forming a “matrix” of photo sensitive elements (50).
S12. A system according to the preceding system embodiment, wherein the imaging sensor (5) comprises 100 to 500 rows of photo-sensitive elements (50), such as, 240 rows and wherein each row comprises 100 to 500 of photo-sensitive elements (50), such as, 340 photo-sensitive elements (50).
S13. A system according to any of the 3 preceding system embodiments, wherein the photosensitive elements (50) are configured to convert incoming light into electric current and store the induced electric charge in an electric charge storage element, such as, a capacitor.

### —Control Unit—

S14. A system according to any of the preceding system embodiments, wherein the ToF sensor further comprises a control unit (1) configured to facilitate the operation of the ToF sensor (10).
S15. A system according to the preceding embodiment and with the features of embodiment S7, wherein the control unit (1) comprises the modulation unit.

### —Optical Element—

S16. A system according to any of the preceding system embodiments and with the features of embodiment S9, wherein the ToF sensor (10) comprises an optical element (7) comprising an optical lens (7) configured to collect the incoming light and focuses it onto the imaging sensor (5).
S17. A system according to the preceding system embodiment, wherein the optical element (7) comprises an optical filter (7) configured as a bandpass optical filter (7), that allows only electromagnetic waves within a certain band of frequencies, such as, infrared light, preferably electromagnetic waves with wavelengths between 700-1400 nm, even more preferably 750-1050 nm to pass through while suppressing the other electromagnetic waves.

### —Mobile Robot—

S18. A system according to any of the preceding system embodiments, wherein the system further comprises a mobile robot (20) configured for land-based motion.
S19. A system according to the preceding system embodiment, wherein the mobile robot (20) is a delivery robot (20), such as, a delivery robot (20) configured for last-mile item delivery.
S20. A system according to any of the 2 preceding system embodiments, wherein the mobile robot (20) is a fully or partially autonomous mobile robot (20).
S21. A system according to any of the 3 preceding system embodiments, wherein the mobile robot (20) comprises the at least one ToF sensor (10).
S22. A system according to any of the 4 preceding system embodiments, wherein the mobile robot (20) comprises the processing unit.
S23. A system according to any of the 5 preceding system embodiments, wherein the mobile robot (20) comprises the memory unit.
S24. A system according to any of the 6 preceding system embodiments, wherein the mobile robot comprises (20) at least one visual camera, preferably, at least one visual stereo camera.
S25. A system according to any of the 7 preceding system embodiments, wherein the mobile robot (20) comprises at least one of: a GPS sensor, odometer, gyroscope, accelerometer, inertial measurement unit.
S26. A system according to any of the 8 preceding system embodiments, wherein the mobile robot (20) comprises at least one front ToF sensor (10) mounted on a front side of the mobile robot (20).
S27. A system according to any of the 9 preceding system embodiments, wherein the mobile robot (20) comprises at least one side ToF sensor (10) mounted on at least one of the sides of the mobile robot (20), preferably at least two side ToF sensors (10) mounted on the sides of the mobile robot (10).
S28. A system according to any of the 10 preceding embodiments, wherein the mobile robot (20) comprises at least one ToF sensor (10) mounted at a height from the ground of 10-70 cm, preferably 20-55 cm, more preferably 40-50 cm.

### —Server—

S29. A system according to any of the preceding system embodiments, wherein the system further comprises a server.
S30. A system according to the preceding system embodiment and with the features of embodiment S18, wherein the mobile robot (20) and the server are configured to communicate.
S31. A system according to the preceding system embodiment and without the features of embodiment S22, wherein the server comprises the processing unit.
S32. A system according to any of the 2 preceding system embodiments and without the features of embodiment S23, wherein the server comprises the memory unit.

### —System Carrying the Localisation Method—

S33. A system according to any of the preceding system embodiments, wherein the system is configured to carry out the method according to any of the preceding method embodiments.
S34. A system according to the preceding embodiment and with the features of embodiment S18, wherein the system is configured to carry out the method according to any of the preceding method embodiments to localise the mobile robot (20).

### BRIEF DESCRIPTION OF THE DRAWINGS

FIG. 1 illustrates an exemplary embodiment of a time-of-flight (ToF) sensor;

FIG. 2 illustrates a measurement procedure using a ToF sensor;

FIG. 3 illustrates an exemplary embodiment of a mobile robot comprising at least one time-of-flight sensor;

FIG. 4a depicts a robot operating in an environment comprising roads and sidewalks;

FIG. 4b depicts the environment of FIG. 4a with features that may be extracted from ToF sensor images captured therein;

FIG. 4c depicts the features that can be extracted in FIG. 4b;

FIG. 5 depicts a flowchart of a method for localisation and optionally for mapping based on at least one image captured by at least one ToF sensor and optionally based on at least one further sensor;

FIG. 6a depicts an exemplary 3D image captured by a ToF sensor;

FIG. 6b depicts the exemplary 3D image of FIG. 6a and features that can be extracted from the 3D image;

FIG. 6c depicts the extracted features from the 3D image of FIG. 6a;

FIG. 6d depicts another exemplary 3D image captured by a ToF sensor;

FIG. 7a depicts an exemplary 2D image captured by a ToF sensor;

FIG. 7b depicts the exemplary 2D image of FIG. 7a and features that can be extracted from the 3D image;

FIG. 7c depicts the extracted features from the 2D image of FIG. 7a;

FIG. 8a depicts a typical behavior of distance measurement uncertainty dependence on distance of exemplary stereo cameras and exemplary ToF sensor;

FIG. 8b depicts the indicated region of FIG. 8a zoomed-in;

FIGS. 8c and 8d depicts the combined distance measurement uncertainty when determining the distance using both the ToF sensor and the stereo cameras;

FIG. 9 depicts a typical behavior of the distance measurement uncertainty of a ToF sensor as a function of amplitude of the reflected light.

### DETAILED DESCRIPTION OF THE DRAWINGS

In the following, exemplary embodiments of the invention will be described, referring to the figures. These examples are provided to give further understanding of the invention, without limiting its scope.

In the following description, a series of features and/or steps are described. The skilled person will appreciate that unless required by the context, the order of features and steps is not critical for the resulting configuration and its effect. Further, it will be apparent to the skilled person that irrespective of the order of features and steps, the presence or absence of time delay between steps can be present between some or all of the described steps.

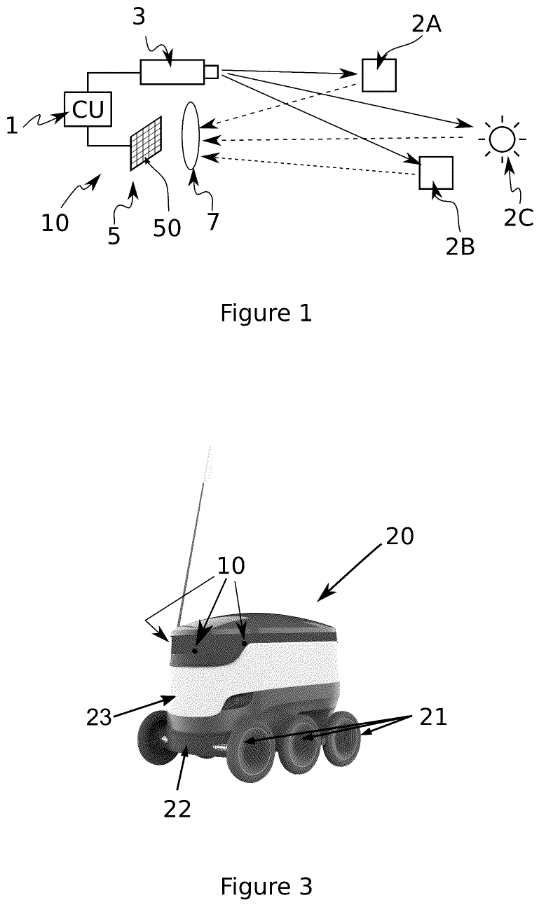

FIG. 1 illustrates an exemplary embodiment of a time-of-flight (ToF) sensor 10 which can be used by the present invention.

A ToF sensor 10 can allow for depth measurements. More particularly, a ToF sensor 10 can measure distances to objects within the field of view of the sensor, based on the known speed of light and by measuring the time-of-flight of photons traveling between the camera and the subject.

A ToF sensor can comprise an illumination unit 3 an imaging sensor 5 and a control unit 1.

Generally, the ToF sensor 10 can utilize time-of-flight measurements of photons travelling a round trip between the ToF sensor 10 and at least one object or surface in the ToF sensor's field of view to obtain distance to the at least one object or surface within its field of view. Photons are emitted by the illumination unit 3 which can be configured to emit pulses of light, continuous electromagnetic waves, modulated electromagnetic waves, etc. The electromagnetic waves emitted by the illumination unit 3 can be reflected or scattered by the surfaces, edges and corners of objects within the field of view of the ToF sensor 10.

The field of view of the ToF sensor 10, which can also be referred to as a captured scene or observed environment, can for example comprise the environment that can be reached by the photons (or electromagnetic waves or light) emitted by the illumination unit 3.

In some embodiments, an illumination intensity threshold can be defined. The field of view of the ToF sensor 10 can be defined by utilizing the illumination intensity threshold. More particularly, the field of view of the ToF sensor 10 can comprise the environment illuminated by the illumination unit 3 with an intensity above the illumination intensity threshold.

In some embodiments, the field of view of the ToF sensor 10, can comprise a rectangular shape that can encompass the environment illuminated by the illumination unit 3 with an intensity above the illumination intensity threshold. For example, all the area or region illuminated by the illumination unit 3 with an intensity above the illumination intensity threshold can be comprised in the rectangular shaped field of view of the ToF sensor. It will be understood that the rectangular shape of the field of view of the ToF sensor 10 refers to the shape that the environment within the field of view (i.e. the observed environment) takes when projected on a 2D surface (e.g. an image).

Part of the reflected or scattered photons (by objects on the field of view of the ToF sensor 10) can be directed back to the ToF sensor 10, more particularly to the imaging sensor 5. Based on the time-of-flight of the photons or effects caused by the time-of-flight of the photons (e.g. phase offset of the received signal compared to the transmitted one) and the known speed of the waves emitted by the illumination unit 3 (i.e. speed of light in the respective medium they are travelling) the distance travelled by the photons can be calculated.

In some embodiments, the distance travelled by the photons can be calculated based on the phase offset of the received signal compared to the transmitted one. In such embodiments, generally a modulated signal can be transmitted. For calculating distance as a function of the phase offset, information regarding the frequency (or wavelength) of the modulated signal may be needed. For example, if the phase offset is 90°, i.e. the received signal is delayed by a quarter of the modulation period, then the distance travelled by the photons can correspond to a quarter of the modulation wavelength. The modulation wavelength can be calculated from the modulation frequency and the speed of light.

Based on the distance travelled by the photons, the distance to objects or surfaces in the field of view of the ToF sensor 10 can be calculated.

In some embodiments, the field of view of the ToF sensor 10, also referred to as captured scene or observed environment, can be defined by utilizing the radiation sensed by the imaging sensor 5. More particularly, the field of view of the ToF sensor 10 can comprise the environment that reflects and/or emits light that can be received or sensed by the imaging sensor 5.

In some embodiments, a received intensity threshold can be defined. The field of view of the ToF sensor 10 can be defined by utilizing the received intensity threshold. More particularly, the field of view of the ToF sensor 10 can be defined such that it can comprise the environment that can emit and/or reflect light that can be received at the imaging sensor 5 with an intensity above the received intensity threshold.

In some embodiments, the field of view of the ToF sensor 10, can comprise a rectangular shape that can encompass the environment that can emit and/or reflect light that can be received at the imaging sensor 5 with an intensity above the received intensity threshold. For example, all the environment that can emit and/or reflect light that can be received at the imaging sensor 5 with an intensity above the received intensity threshold can be comprised in the rectangular shaped field of view of the ToF sensor. It will be understood that the rectangular shape of the field of view of the ToF sensor 10 refers to the shape that the environment within the field of view (i.e. the observed environment) takes when projected on a 2D surface (e.g. an image).

In some embodiments, the field of view of the ToF sensor 10 can comprise a fixed size. For example, the field of view of the ToF sensor 10 can comprise a fixed rectangular shape when projected on a 2D surface.

The time-of-flight sensor 10 can be configured to operate with electromagnetic waves, such as infrared light, i.e., radiation with wavelengths between 700 nm to 1 mm. Generally, time-of-flight sensors 10 can operate with electromagnetic waves in the near infrared (nIR) part of the electromagnetic spectrum, i.e. with near infrared light. In a preferred embodiment of the present invention, the ToF sensor 10 can operate with electromagnetic waves with wavelengths between 700-1400 nm, preferably 750-1050 nm.

The illumination unit 3 can be configured to provide active or artificial illumination while the ToF sensor 10 measures properties (e.g. depth measurements) of the environment. The illumination unit 3 can emit infrared light, such as, near infrared light, preferably electromagnetic waves with wavelengths between 700-1400 nm, more preferably 750-1050 nm.

The illumination unit 3 can be a semiconductor light emitter. For example, the illumination unit can be a laser diode (LD) 3 or a light-emitting diode (LED) 3. Further, the illumination unit 3 can be configured to allow fast switching. In this regard, the use of a semiconductor based light emitter 3, such as, a laser diode or light emitting diode, may be advantageous. Fast switching of the illumination unit 3 may further allow emitting modulated light.

The imaging sensor 5 can be configured to be sensitive to electromagnetic waves with particular frequencies, such as, the operating frequencies of the ToF sensor 10 and/or illumination unit 3. The imaging sensor 5 can be configured to be sensitive to infrared light, such as, near infrared light, preferably electromagnetic waves with wavelengths between 700-1400 nm, more preferably 750-1050 nm. Thus, when the electromagnetic waves (that the imaging sensor 5 is sensitive to) arrive at the imaging sensor 5, electric current can be generated by the imaging sensor 5. The generated electric current can be an indicator of at least one of: the time-of-arrival (ToA) of the electromagnetic wave, the time-of-flight (ToF) of the photons emitted by the illumination unit 3 and the amount of electromagnetic energy received.

In some embodiments, the imaging sensor 5 can be an infrared sensor 3 with a sensitivity at wavelengths 400-1100 nm, preferably with higher sensitivity at wavelengths between 750-1050 nm, even more preferably with higher sensitivity at wavelengths between 800-970 nm.

In such embodiments, the illumination unit 3, preferably comprising an infrared light source 3, can be configured such that its spectral emission extends between wavelengths of 750-950 nm, with maximum emission power at wavelengths between 830-870 nm, such as with a centroid wavelength of 850 nm.

Alternatively, in such embodiments, the illumination unit 3, preferably configured as an infrared light source 3, can be configured such that its spectral emission extends between wavelengths of 800-1050 nm, with maximum emission power at wavelengths between 930-970 nm, such as with a centroid wavelength 940 nm.

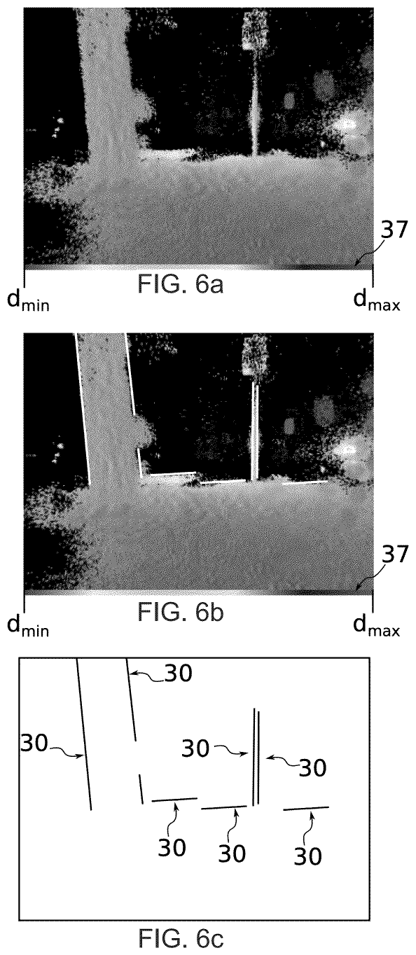

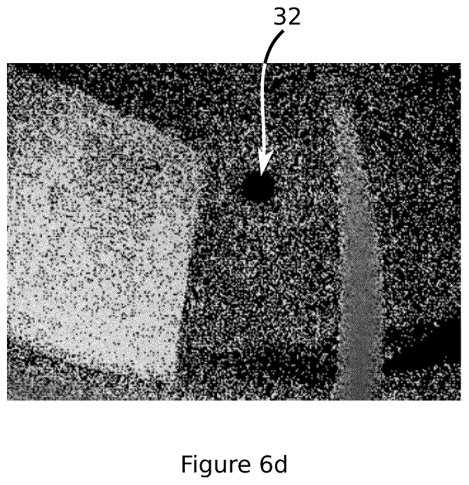

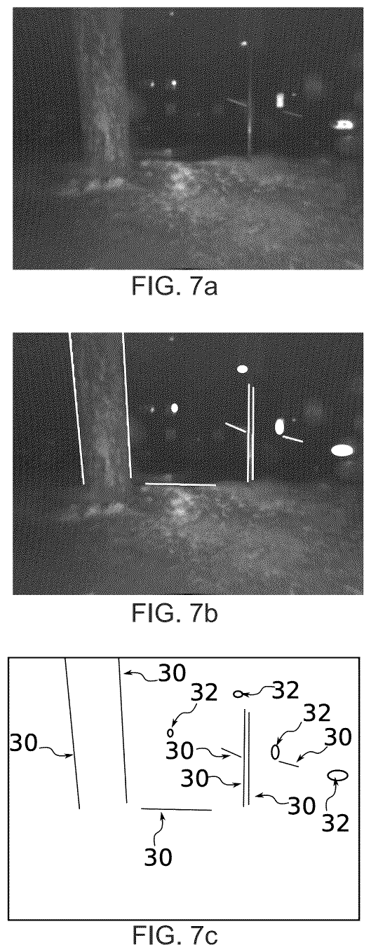

With such configuration, the light emitted by the illumination unit 3 can preferably be received by the imaging sensor 5. Similarly, the light emitted by the illumination unit 3 can be reflected by objects in the observed environment of the ToF sensor and can be received by the imaging sensor 5. This can allow for intensity measurements of the received lights which can facilitate the generation of a 2-dimensional (2D) ToF image (see FIG. 7). Said configuration can also allow for ToF measurements (e.g. a difference in time or phase shift between the transmitted and received light) which can facilitate the generation of a 3-dimensional (3D) ToF image (see FIG. 6)

Alternatively, the imaging sensor 5 can be sensitive to electromagnetic waves of any frequency or electromagnetic waves having a frequency within a wider range of frequencies than the operating frequencies of the ToF sensor 10 and/or illumination unit 3. For example, the imaging sensor 5 can be sensitive to visible light and infrared light.

In some embodiments, optical filters 7 can be provided in an optics component 7 of the ToF sensor 10. The optical filters 7 can be positioned in front of the imaging sensor 5, preferably covering the imaging sensor 5. The optical filters 7 may be configured as a bandpass optical filter 7, that can be configured to allow only electromagnetic waves within a certain band of frequencies to pass through (and thus reach the imaging sensor 5) while suppressing the other electromagnetic waves. Thus, the optical filter 7 can allow passage only to electromagnetic waves with frequencies similar to or comprising the operating frequencies of the ToF sensor 10 and/or illumination unit 3. For example, the optical filter 7 can allow passage of infrared light, such as, near infrared light, preferably electromagnetic waves with wavelengths between 700-1400 nm, more preferably 750-1050 nm. In other words, the optical filter 7 can be configured to suppress unwanted electromagnetic waves (e.g. visible light) that can interfere with the measurements and provide incorrect result. Thus, by suppressing the unwanted electromagnetic waves, such as, light that is not emitted by the illumination unit 3, the accuracy of the measurements done by the ToF sensor 10 can be improved.

The imaging sensor 5 can comprise a plurality of photo sensitive elements 50, e.g., photodiodes 50. Each photo sensitive element 50 of the imaging sensor 5 can be configured to convert incoming light into electric current. The photo sensitive elements 50 can preferably be arranged as sensor array, that is, in a certain geometric pattern, for example, as rows stacked one above the other forming a “matrix” of photo sensitive elements 50. The imaging sensor 5 can, for example, comprise a size of 320×240 photo sensitive elements 50, i.e. the imaging sensor 5 can comprise 240 rows of photo sensitive elements 50 stacked one above the other with each row comprising 320 photo sensitive elements 50.

In this manner, the imaging sensor 5 can be configured to output an image (referred herein as a ToF sensor image, or for brevity as ToF image—see e.g., FIG. 6a and FIG. 7a—to differentiate from visual images captured by visual cameras). Each pixel of the ToF sensor image can correspond to a measurement conducted by a respective photo sensitive element 50 of the imaging sensor 5. Hence, the pixel resolution of the ToF sensor image can be defined by the size of the imaging sensor 5 (i.e. the number of photo sensitive elements 50 comprised therein).

Usually, the imaging sensor 5 is also referred to as a pixel field 5, and each photo sensitive element 50 as a pixel 50. Thus, for example, an imaging sensor 5 with a 320×240 pixel field can output a ToF sensor image with a resolution of 320×240 pixels (i.e. the width of the image being 320 pixel and the height 240 pixel). Further, a region of interest can be defined—that is, only part of the pixels 50 of the imaging sensor 5 can be used for measurements. Thus, the field of view of the ToF sensor 10 can be decreased. The size of the ToF sensor image that is output by the ToF sensor 10 can also be decreased. This may increase the speed of obtaining the measurement data (e.g. the frame rate of capturing the ToF sensor images).

The optics element 7 can comprise a lens 7. The lens 7 can be configured to collect the incoming light (i.e. photons) and focuses it onto the imaging sensor 5. Additionally, a lens can also be provided in front of the illumination unit 3 (not shown). The lens can be configured such that a better illumination of the observed scene of the ToF sensor 10 can be achieved. For example, the lens in front of the illumination unit 3, if provided, may focus the emitted light on a preferred portion of the observed environment, may allow a more evenly distribution of the emitted light on the observed environment, etc.

The control unit 1 can comprise computational and interface devices facilitating the control and operation of the ToF sensor 10. The control unit 1 can activate and deactivate the illumination unit 3 and the imaging sensor 5. The control unit 1 can comprise an input/output (I/O) interface that can facilitate interfacing with other devices, such as, microcontrollers, processing units, integrated circuits, field programable gate arrays, system-on-chip, light emitters, light sensors and/or other similar devices. The control unit 1 can also be integrated or part of another device, such as, microcontrollers, processing units, system-on-chip and/or other similar devices. For example, the control unit 1 can be part of a controlling system of a mobile robot 20 (see FIG. 3).

Further, the control unit 1 can be configured to interface with the illuminating unit 3 and the imaging sensor 5. For example, the control unit 1 can be configured to receive machine instructions (i.e. electric signals) as input (e.g. from a microcontroller programmed by a human operator), and operate the illumination unit 3 and the imaging sensor 5 to carry out the input instruction. The control unit 1 can be configured to “understand” or differentiate different instructions (e.g. different combination of input signals) and operate the illumination unit 3 and the imaging sensor 5 in the corresponding mode of operation to carry out the respective instruction.

The controlling unit 1 can further comprise (or be connected to) drivers (not shown) configured to properly activate the illumination unit 3 and/or imaging sensor 5. Said drivers may also be comprised by or integrated in the illumination unit 3 and/or imaging sensor 5. The control unit 1 can further comprise (or be connected to) modulator/demodulators, timers, oscillators, signal phase discriminators configured to facilitate measuring the time-of-flight and/or of or the distance travelled by the signals received by the imaging sensor 5. Said modulator/demodulators, timers, oscillators, signal phase discriminators can alternatively be comprised by or integrated in the illumination unit 3 and/or imaging sensor 5.

The ToF sensor 10 can output distance data, e.g. 2 to 16-bit distance data per pixel (i.e. each pixel outputs data—e.g. an integer data structure—of a maximum size between 2 to 16-bits per measurement, also referred to as bit depth). That is, in this example wherein the ToF sensor can comprise a bit depth between 2 to 16-bits, the imaging sensor 5, more particularly the pixels 50 of the imaging sensor 5, can measure and differentiate 4 (i.e. 2 in the power of 2) to 65536 (i.e. 2 in the power of 16) values within the maximum distance that can be measured by the ToF sensor (also referred to as unambiguity distance). The distance resolution (i.e. minimum measurable or distinguishable distance) of the ToF sensor 10 can be determined based on the unambiguity distance (see below) of the ToF sensor 10 divided by the number of differentiable values. That is:

$${D}_{resolution} = \frac{{D}_{unambiguity}}{{2}^{Number \_ of \_ distance \_ data \_ bits}}$$

It is noted that the above data sizes (i.e. bit depth) that can be output by the ToF sensor are provided simply for illustration. In general, the ToF sensor 10 can output distance data of any size, that is, can comprise any bit depth. Generally, ToF sensors 10 outputting distance data per pixel per measurement with larger size (i.e. larger bit depth) are more preferable as they can comprise smaller minimum distance that they can measure, hence a better accuracy. For example, a ToF sensor outputting 12-bits per pixel measurement can be more preferable than a ToF sensor outputting 8-bits per pixel measurement. Similarly, a ToF sensor outputting 16-bit (or more, e.g. 32-bit or 64-bit) per pixel measurement can be more preferable than a ToF sensor outputting 12-bit per pixel measurement. However, the higher the bit depth the more the quantization levels that would need to be differentiated, which can be more challenging.

The more bits each pixel can output for the distance data the smaller the minimum distance that can be distinguished (i.e. the better the distance resolution) and hence the better the accuracy of the measurement. For example, if the unambiguity distance of the ToF sensor is 30 m, and the sensors output 12-bit distance data, then the distance resolution is approximately 7.3 mm (30 m divided by 4096).

The measurement of distance by the ToF sensor 10 can be facilitated by modulating the light emitted by the illumination unit 3 with a carrier wave. The frequency of the carrier used for the modulation (i.e. modulation frequency) can be 1 to 100 MHz, such as, to 30 MHz, preferably 10 to 20 MHz. The modulation frequency affects the unambiguity distance and the distance resolution. The unambiguity distance is inversely proportional to the modulation frequency. More particularly, the unambiguity distance (D_{unambiguity}) can be obtained from the modulation frequency (f_{modulation}) and speed of light (c) using the following formula:

$${D}_{unambiguity} = \frac{c}{2 \cdot {f}_{modulation}}$$

On the other hand, the distance resolution is directly proportional to the unambiguity distance. Thus, the higher the modulation frequency the smaller the unambiguity distance can be. The smaller the unambiguity distance the smaller the minimum distance that can be distinguished is (i.e. the better the distance resolution). For example, if the modulation frequency is 10 MHz, the unambiguity distance is approximately 15 m and for a 12-bit distance data output the distance resolution is approximately 3.6 mm. If the frequency of the carrier is 20 MHz, the unambiguity distance is 7.5 m and for a 12-bit distance data output the distance resolution is approximately 1.8 mm.

It will be noted, that ambiguity in distance can exist in embodiments wherein the distance is calculated based on the phase shift (or offset) of the received signal compared to the transmitted one. The phase wraps around 2π radians and as a result the distance also wraps around the wavelength of the signal. However, in other embodiments wherein different techniques can be used for measuring the distance, the unambiguity distance may be differently calculated and/or there may not be ambiguity in distance. For example, the distance can also be calculated based on the attenuation of a received signal. In such embodiments, there can be no ambiguity on the distance measurements. However, the calculation of distance based on phase shift can typically provide more accurate results. In some embodiments, the distance to the objects in the field of view of the ToF sensor 10 can be measured. As illustrated in FIG. 1, a measurement of the distance between the ToF sensor 10 and the objects 2A, 2B and 2C can be performed. In general, the ToF sensor 10 can be configured to measure the distance to any object 2 that can reflect or scatter the light emitted by the illumination unit 3, within the field of view of the ToF sensor 10.

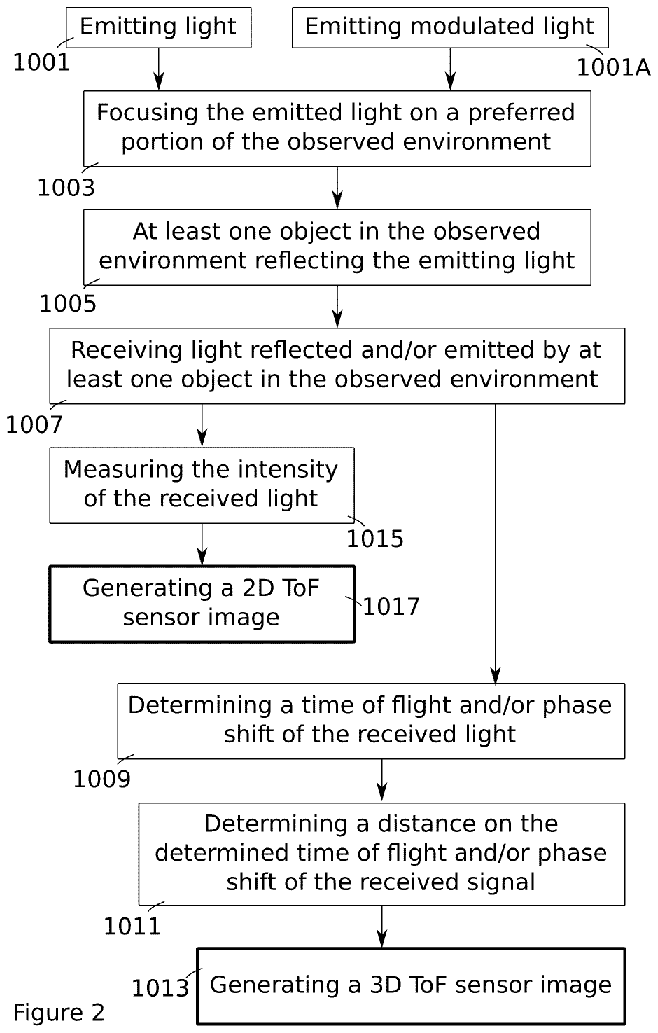

With reference to FIG. 2 an exemplary method of capturing a 2D and/or 3D ToF sensor image (see FIG. 6a and FIG. 7a for 3D and 2D exemplary ToF sensor images) will be described. More particularly, FIG. 2 illustrates a measurement method using the ToF sensor 10. Further, the measurements obtained using the ToF sensor can be used to generate a 2D and/or 3D ToF sensor image.

In a step 1001 the method comprises emitting light, preferably infrared light (as discussed above). Alternatively or additionally, in a step 1001A modulated light can be emitted. This can be advantageous when performing distance measurements based on the phase offset of the received signal compared to the transmitted one. Step 1001 may comprise modulating the intensity or amplitude of light waves (e.g. infrared light) with a carrier, e.g. a square or sine carrier wave. The carrier wave can have a frequency between 1 to 100 MHz, such as, 5 to 30 MHz, preferably 10 to 20 MHz. For example, an amplitude modulation scheme (e.g. pulse width modulation) can be used to modulate the light waves with a carrier wave (e.g. a square wave). The illumination unit 3 may be utilized for carrying out step 1001 and/or 1001A.

In an optional step 1003, the emitted light may be focused on a preferred portion of the observed environment. In this step, a lens may be positioned in front of the illumination unit 3 which shapes the emitted waves according to a predetermined pattern such that a preferred portion of the observed environment can be illuminated.

In a step 1005 the emitted modulated light can be reflected and/or emitted by at least one object and/or surface in the observed environment (i.e. field of view) of the ToF sensor 10. For example, referring to FIG. 1, objects 2A, 2B and 2C may be illuminated by the emitted light in steps 1001 and 1001A and may reflect the light. Part of the reflected or scattered modulated light can be captured by the imaging sensor 5, in a step 1007. Note that objects in the field of view of the ToF sensor 10 may comprise light sources (e.g. urban lights, car lights, windows of illuminated rooms, sunlight etc.). For example, in FIG. 1 the object 2C depicts a light source 2C. In this case, also the light (or a part of it) emitted by the light source 2C can be received by the imaging sensor 5.

Generally, such light sources 2C can be configured to emit light in the visible part of the spectrum (i.e. urban light used for illumination or sunlight). However, their emitting spectrum may also comprise “leakage” on the infrared part of the spectrum—more particularly in the part of the spectrum that the imaging sensor 5 can sense. In some embodiments, the optical lens 7 may filter unwanted light that is generated by external light sources 2C. Emitting modulated light (step 1001A) may be advantageous, in this regard, to easily differentiate reflected light coming from the illumination unit 3 from light that is emitted from objects in the observed environment or sunlight.

In a step 1009 the time-of-flight of the received light may be determined. For example, a first timestamp can be recorded when the light is emitted in step 1001 and/or 1001A and a second time stamp can be recorded when the light is received in step 1007. The difference between the second timestamp and the first timestamp can be used to determine the time-of-flight of the received signal. Note, that light from external light sources may result in a time-of-flight equal to zero (or very close to zero) as it can be directly sensed by the imaging sensor 5. On the other hand, light emitted in step 1001 may need to complete a round-trip from the illumination unit 3 to the objects in the observed environment and back to the imaging sensor 5—which requires a certain time (the time-of-flight).

Alternatively or additionally, in step 1009 the phase of the received electromagnetic waves can be determined and the phase shift between the received electromagnetic waves (in step 1007) and the transmitted electromagnetic waves (in step 1001/1001A) can be calculated.

In some embodiments, step 1009 may comprise taking 2 to 4 samples of the received signal and calculating the phase of the received signal using reverse tangent function (atan), for example as follows:

$$Signal Phase = a tan ( \frac{{Sample}_{3} - {Sample}_{1}}{{Sample}_{2} - Sampl {e}_{0}} )$$

$$or$$

$$Signal Phase = a tan ( \frac{- {Sample}_{1}}{- {Sample}_{0}} )$$

It will be understood that the above (and below) formulas are only some exemplary ways of calculating the parameters required to generate a 2D and/or 3D ToF sensor image, such as, the phase of the received signal, the phase shift between the transmitted light and received light, the time-of-flight of the received light, the distance travelled by the received light and/or distance to objects in the observed environment or captured scene. Other mathematical and signal processing tools may be utilized as well in step 1009 to determine the required parameters.

In a step 1011, a distance may be determined based on the time-of-flight of the received signal. For example, the distance travelled by the received light may be determined based on the time-of-flight (ToF) of the received light using, e.g., the following formula:

$$D = c \cdot \frac{ToF}{2}$$

For example, each photo sensitive element 50 (see FIG. 1) of the imaging sensor 5 may receive reflected and/or emitted light by at least one object in the observed environment (step 1007) and for each photo sensitive element 50 the time-of-flight of the received light may be determined in step 1009 and in step 1011 a distance to the object reflecting and/or emitting the light received in step 1007 may be calculated.

Alternatively or additionally, in some embodiments wherein the phase shift is determined in step 1009, the distance traveled by the received light can be obtained utilizing the calculated phase shift. In one particular embodiment this can be achieved using, for example, the formula:

$$D = {D}_{u n ambiguity} \cdot \frac{Phase Shift [ radians ]}{2 π} = \frac{c}{2 \cdot {f}_{modulation}} \cdot \frac{Phase Shift [ radians ]}{2 π}$$

If the emitted waves in step 1001/1001A travels for longer than a wavelength then the distance to the target object will be underestimated. As discussed above, the ToF sensor 10 can measure accurate distances only within the unambiguity distance. For example, a signal shifted by 9π/4 radians (i.e. 405°) will provide the same distance result (when the distance is calculated as a function of the phase shift) as a signal shifted by π/4 radians (i.e.) 45°). Thus, a far object may appear as being close.

Other sensors may be used to solve the ambiguity of the calculated distance of objects when said distance is calculated as a function of phase shift. One example may be the use of stereo cameras—which can be used to provide a second estimate of the distance. Generally, stereo cameras can provide inaccurate distance estimation particularly for far objects as small changes in image space correspond to large changes in distance. On the other hand, ToF sensors 10 can provide a more accurate estimation of the distance to an object, however as discussed, they suffer from distance ambiguity. But considering the distance estimate provided by the stereo cameras and the distance estimate provided by the ToF sensor 10, the ambiguity of the ToF sensor 10 distance estimation can be removed and a more accurate estimation of the distance (particularly of far object) can be achieved.

More particularly, the distance measurement uncertainty (which for the sake of brevity can also be referred to as distance uncertainty or error) of the ToF sensor 10, can depend, among others, on the ambient light, unambiguity distance (or modulation frequency) and amplitude of reflected light. In other words, a high amplitude of the ambient light (which can be considered as noise during the distance measurement) can contribute on decreasing the signal-to-noise ratio at the imaging sensor 5. Generally, a lower signal-to-noise ratio at the imaging sensor 5 can contribute on increasing the distance measurement uncertainty of the ToF sensor 10.

The distance measurement uncertainty of the ToF sensor 10 can increase with the increase of the intensity of the ambient light. The ambient light may comprise light emitted by light sources different from the illumination unit 3 (see FIG. 1), such as, sunlight, light from urban lights, etc.

The ambiguity distance can also affect the accuracy of distance measurements by the ToF sensor 10. Generally, the larger the unambiguity distance the larger the distance measurement uncertainty.

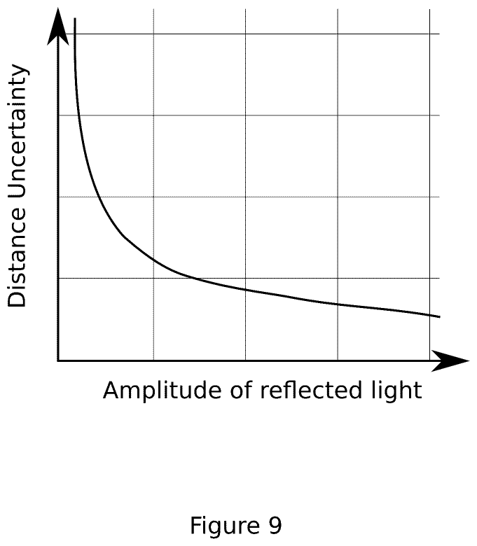

The amplitude of the reflected light can be another factor that impacts the distance measurement uncertainty for a ToF sensor 10. The amplitude of the reflected light can be defined as the measured amplitude at the imaging sensor 5 of the light emitted by the illumination unit 3, reflected by an object 2 (see FIG. 1) and received by the imaging sensor 5. A typical behavior of the distance measurement uncertainty as a function of amplitude of the reflected light is depicted in FIG. 9. As it can be noticed therein, the distance measurement uncertainty generally decreases with the increase of the amplitude of the reflected light. In other words, a high amplitude of the reflected light can contribute on increasing the signal-to-noise ratio at the imaging sensor 5. Generally, a high signal-to-noise ratio at the imaging sensor 5 can contribute on lowering the distance measurement uncertainty of the ToF sensor 10.

The amplitude of the received reflected light can be increased by increasing the amplitude of the emitted light (i.e. increasing the light emitting power of the illumination unit 3 of the ToF sensor 10, see FIG. 1). Furthermore, the amplitude of the received reflected light can be increased by increasing the exposure time (i.e. the time during which the imaging sensor 5 senses incoming light), such that low amplitude reflections can be measured better. However, the increase of the transmission power of the illumination unit 3 and/or increase of the exposure time of the imaging sensor 5 may cause oversaturation of high amplitude reflections. The amplitude of the reflected light can also depend on the reflecting surface properties.

On the other hand, for stereo cameras the distance measurement uncertainty generally increases with distance, usually with the square of the distance. The distance measurement uncertainty of stereo cameras, further depends on the lens focal length of the cameras, camera resolution and distance between the two cameras in the stereo pair.

Generally, increasing the resolution of the cameras can decrease the distance measurement uncertainty. For example, if the pixel size is 1 degree, then the smallest parallax—the difference in the apparent position (on the image) of an object or feature viewed from two different cameras—that can be measured, can be no smaller than 1 degree. However, if each pixel corresponds to 0.5 degrees, then the smallest measurable parallax can be at least 0.5 degrees. In other words, higher resolution can allow for finer measurements of parallax. Distance to an object is inversely proportional to the parallax, so a finer measurement of the parallax can provide a more precise measurement of the distance and thus, decrease the distance measurement uncertainty.

On the other hand, increasing the distance between the cameras in the stereo pair can contribute on decreasing the distance measurement uncertainty. However, the distance between the cameras can influence the overlap between the fields of view of the respective cameras in the stereo pair. More particularly, the more apart the cameras in the stereo pair are positioned the smaller the overlap can be. A small overlap between the fields of view of the cameras in the stereo pair can make it more challenging for matching the corresponding pixels between the two images provided by the stereo cameras. Hence, the selection of the distance between the cameras in the stereo pair involves a trade-off between computational resources required for solving the correspondence problem and accuracy.

In addition, the field of view of the cameras can also affect the distance measurement. In one hand, a wider field of view of the cameras in the stereo pair can increase the amount of the surroundings that can be “seen” by the cameras. At the same time, the amount of overlap between the respective fields of view of the cameras can be increased. For performing a distance measurement, it may be required that an object or feature is positioned within the overlap region of the fields of view. This can allow calculation of distance through triangulation techniques—i.e. finding the position of a point, object or feature relative to at least two reference points (the known camera locations) using at least two angle measurements performed based on the position of the point, object or feature on the images captured by the cameras. Note that other techniques may be utilized additionally or alternatively for estimating the distance to points, objects or features from stereo camera images. Hence a wider field of view of the cameras can result in a bigger overlap between the fields of view of the cameras which in turn can allow objects positioned closer to the stereo cameras to be within the overlap region (thus allowing distance measurement e.g. through triangulation techniques). However, when increasing the field of view of the cameras at the same time the field of view per pixel is increased. Increasing the field of view per pixel can increase the distance measurement uncertainty. As a result, the selection of the field of view of the cameras in the stereo pair involves a trade-off between minimum measurable distance and accuracy.

Thus, different stereo camera pairs can be configured to comprise different distance measurement uncertainty and different minimum measurable distance. Generally, decreasing the minimum measurable distance may increase the distance measurement uncertainty. Similarly, decreasing distance measurement uncertainty can increase the minimum measurable distance.

For example, the mobile robot 20 (see FIG. 3) can have front stereo cameras positioned in the front of the mobile robot 20 and side stereo cameras positioned at the sides of the mobile robot 20. The positioning of the front and side stereo cameras on the mobile robot 20 can be similar to the positioning of the front and side ToF sensors 10 on the mobile robot 20, as will be discussed with reference to FIG. 3.

For example, in a particular embodiment of the mobile robot 20, the front stereo cameras can be configured for providing accurate distance measurements to objects that are close to the cameras (consequently to the robot as well). However, this configuration of the front stereo cameras may come at the expense of an increased uncertainty for measuring the distance of far objects from the front stereo cameras. On the other hand, the side stereo cameras can be configured for measuring with an improved accuracy distances to objects being far from the cameras. This configuration of the stereo cameras can generally limit the ability of the side stereo cameras for measuring distances to objects being close to the side stereo cameras. Due to such configurations, the front and the side stereo cameras may be characterized by different distance measurement uncertainties.

In some embodiments, the front stereo cameras can be configured to measure distances of at least 15 cm and at most 60 cm with a distance uncertainty of less than 0.5 cm, while the side stereo cameras can be configured to measure distances of at least 50 cm and at most 100 cm with a distance uncertainty of less than 0.5 cm. Alternatively or additionally, the front stereo cameras can be configured to measure distances of at least 15 cm and at most 85 cm with a distance uncertainty of less than 1 cm, while the side stereo cameras can be configured to measure distance of at least 50 cm and at most 150 cm with a distance uncertainty of less than 1 cm. Alternatively or additionally, the front stereo cameras can be configured to measure distances of at least 15 cm and at most 180 cm with a distance uncertainty of less than 5 cm, while the side stereo cameras can be configured to measure distances of at least 50 cm and at most 320 cm with a distance uncertainty of at most 5 cm. Note that the above ranges are provided for exemplary purposes and other configurations of the cameras can be achieved as well.

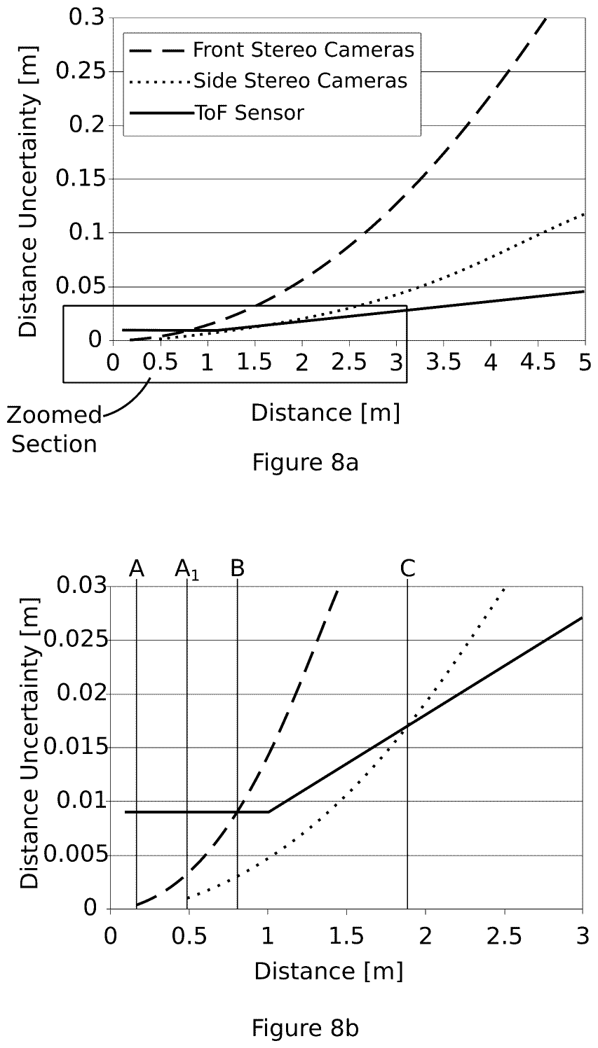

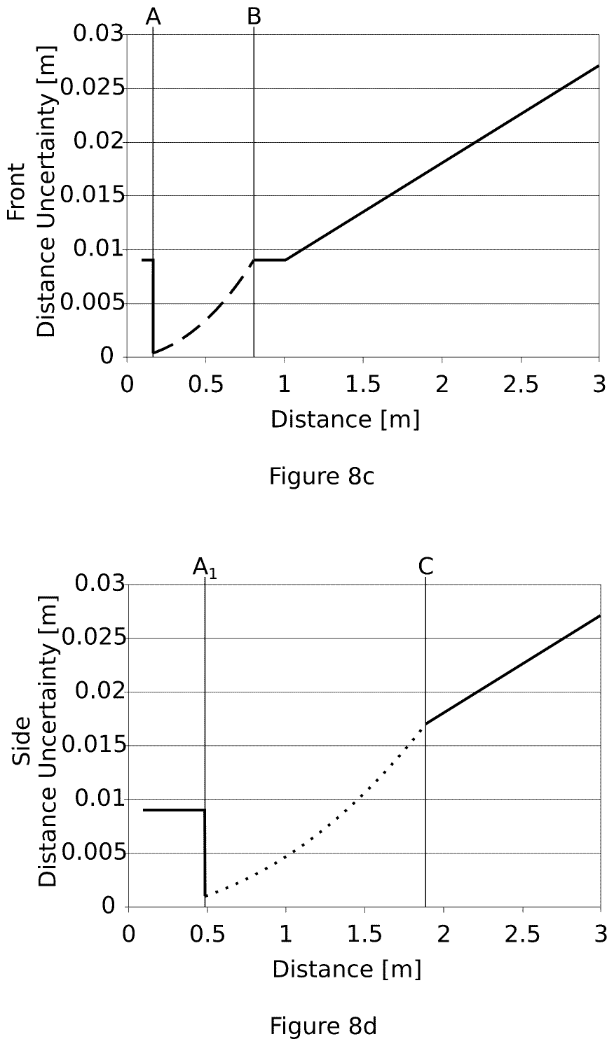

FIG. 8a depicts a typical behavior (i.e. idealized graph) of distance measurement uncertainty dependence on distance for exemplary front and side stereo cameras and exemplary ToF sensor 10. FIG. 8b depicts the indicated region of FIG. 8a zoomed-in.

As it can be noticed from the graphs in FIGS. 8a and 8b, the stereo cameras can typically comprise a minimum detection distance that is larger than the minimum detection distance of the ToF sensor 10. That is, the ToF sensor 10 can have a minimum measurable distance smaller than distance A which depicts the minimum measurable distance of the front stereo cameras (see FIG. 8b) and smaller than distance A1 which depicts the minimum measurable distance of the side stereo cameras (see FIG. 8b).

Further, from the graph it can be noticed that for small distances the ToF sensor 10 can typically comprise a larger distance measurement uncertainty as compared to stereo cameras. For example, for distances between distance A and distance B (for front stereo cameras) and for distances between distance A and distance C (for side stereo cameras) the stereo cameras comprise a smaller distance measurement uncertainty compared to ToF sensor 10.

Further still, from the graphs it can be noticed that for larger distances the ToF sensor 10 can typically comprise a lower distance measurement uncertainty compared to stereo cameras. It can be noticed from the typical behavior graphs of FIGS. 8a and 8b that the ToF sensor distance measurement uncertainty increases almost linearly with distance while the stereo camera distance measurement uncertainty increases almost quadratically with distance). That is, for distances larger than B the ToF sensor 10 comprises a lower distance measurement uncertainty compared to the front stereo cameras and for distances larger than C the ToF sensor 10 comprises a lower distance measurement uncertainty compared to the side stereo cameras.

In some embodiments, a mobile robot 20 as depicted in FIG. 3 can be equipped with front ToF sensor 10, front stereo cameras, side ToF sensors 10 and side stereo cameras. These sensors can be used for measuring distances to objects. Furthermore, their measurements can be combined to improve the accuracy of distance measurements. For example, the ToF sensor 10 can be used to measure distance to very close objects (e.g. objects positioned closer than distance A) for which the stereo cameras cannot measure a distance. Further, for near objects (e.g. objects between distance A and B for the front or A and C for the sides) the measurements of the stereo cameras can be used. Further still, for far objects (e.g. objects further than distance B for the front or C for the sides) the measurements of the ToF sensors can be used. In the latter case, the ambiguity of the ToF sensor measurement (for objects further than the unambiguity distance D_{unambiguity}) can be solved by using the measurement of the stereo cameras.

For example, a particular ToF sensor 10 can have an unambiguity distance of 10 meters. An object appears to be 3 meters away according to the ToF sensor 10 and 14 meters away according to the stereo cameras. The measurement of the stereo camera can be used to determine that the object is further than the unambiguity distance of the ToF sensor 10. With this information, it can be determined that the object is 13 meters away. Note that the measurement of the ToF sensor is used (i.e. 10+3 meters). Also, it should be noted, that in this example the ToF sensor 10 and stereo cameras use a common reference system to measure distance. The common reference system can be generated during a calibration step between the stereo cameras and the ToF sensor 10.

FIGS. 8c and 8d depicts the distance measurement uncertainty when determining the distance using both the ToF sensor 10 and the stereo cameras for the front and side stereo cameras and ToF sensors respectively. As it can be noticed, the combined error curves depict a lower distance uncertainty compared to the error curves of the individual sensors (depicted in FIG. 8b). Hence, the combination of ToF sensors 10 and stereo cameras can be advantageous for performing distance measurements.

In some embodiments, an offset distance (D_{offset}) can be added to the result of the previous formula. The offset distance can be obtained in a calibration step of the ToF sensor 10 and can compensate measurement errors of the ToF sensor 10. The distance offset may also depend on the temperature of the ToF sensor 10. Hence, during the calibration of the ToF sensor 10 the dependence of the offset distance on the temperature of the ToF sensor 10 can be obtained. In other words, the distance to the objects can also be measured using

$$D = {D}_{unambiguity} \cdot \frac{Phase Shift [ radians ]}{2 π} + {D}_{offset}$$

The above distance measurement algorithm can be carried out for each pixel 50 of the imaging sensor 5. Thus, for each pixel 50 a distance can be calculated and a 3D ToF sensor image (e.g. see FIG. 6a) can be obtained in step 1013.

The above discussed steps 1009, 1011 and 1013 can be carried out by the controlling unit 1 of the ToF sensor 10. Hence, at step 1013 the controlling unit of the ToF sensor 10 can output a 3D ToF sensor image. For example, in step 1013 a matrix can be output, wherein each element in the matrix can correspond to a measured distance calculated based on the received light from each pixel 50 (see FIG. 1) of the imaging sensor 5.

Alternatively or additionally, step 1007 can be followed by step 1015. In step 1007, the intensity of the received light (which is received in step 1007) can be measured. The intensity of the received light can be used to generate a 2D ToF sensor image in step 1017. For example, the measured intensity of the received light can be mapped into a predefined range between a minimum and a maximum value, e.g. a grayscale to obtain a grayscale image (see FIG. 7a).

Step 1015 can be carried out by each of the pixels 50 of the imaging sensor 5. Thus, each pixel 50 of the imaging sensor 5 can measure the intensity of the received light. Step 1017 can be carried out by the controlling unit 1 of the ToF sensor 10. Hence, at step 1017 the controlling unit can output a 2D ToF sensor image (i.e. a grayscale image).

Thus, the ToF sensor 10 can also be used for the so-called grayscale imaging. In this mode, the ToF sensor 10 can be configured to sense the received light (similar to a visual camera) and measure the intensity of the received light. The ToF sensor 10 can be configured to measure with active illumination or without active illumination. In the former case (with active illumination) the received light can be filtered such that only light that is emitted by the illumination unit 3 can be received. In the latter case (without active illumination), the ambient light can be measured. As e result, a 2D image can be generated (e.g. see FIG. 7a). Alternatively, active illumination can be provided by the illumination unit 3 and all incoming light (including light that is emitted by the illumination unit 3 and light from external sources) can be sensed.

It will be understood, that the above description of the time-of-flight sensor 10 is only illustrative and exemplary. Other configurations of time-of-flight sensors 10 can also be used with the current invention.

FIG. 3 shows an embodiment of a mobile robot 20. The robot 20 can comprise wheels 21 adapted for land-based motion. The wheels 21 can be mounted to a frame 22. A body 23 can be mounted on the frame 22. Body 23 can comprise an enclosed space (not shown), that can be configured to carry at least one item for delivery. Further, the mobile robot 20 can comprise a motion generation system (not shown), e.g., an electric and/or combustion engine, powered by a battery system and/or fuel. Further still the mobile robot 20 can comprise at least one controller system (not shown) which can be programmed and/or configured to receive instructions from a user terminal (not shown), e.g. remotely. The controller system of the robot 20 can facilitate partial or a fully autonomous operation of the mobile robot 20.

In some embodiments, the mobile robot 20 can be a delivery robot 20. It can, for example, be configured to carry out last-mile delivery. Further, the mobile robot 20 can operate autonomously or partially autonomously. For example, the autonomy level of the mobile robot 20 can be between the levels 1 to 5, as defined by the Society of Automotive Engineers (SAE) in J3016—Autonomy Levels. In some embodiments the mobile robot 20 can be controlled (e.g. steered) by a human operator through a user terminal (i.e. the user terminal can exchange data with the mobile robot). In some other embodiments, the robot 20 is assisted by the human operator only in some instances, e.g. in particular situations imposing more risk, such as, crossing a road. In other embodiments, the robot 20 can be fully autonomous—that is, can navigate, drive and carry out an assigned task without human intervention.

Driving and navigation of mobile robots 20 can be facilitated by a computerized view of its surroundings (i.e. computer vision). Thus, the mobile robot 20 can be equipped with various sensors that provide information of the surroundings. Among other sensor devices, the mobile robot 20 can comprise at least one ToF sensor 10. The ToF sensor can be configured to provide depth information related to the surroundings (see FIG. 6) and/or 2D views of the surroundings (see FIG. 7) of the ToF sensor 10. The ToF sensor 10 can be provided in the front of the robot 20 (as shown in FIG. 3) and/or on the sides and/or the rear of the robot 20.

The mobile robot 20 can comprise further sensors (not shown), such as, at least one of: at least one camera e.g. stereo cameras, configured to capture visual images, at least one radar configured to detect objects (e.g. moving objects) in the surroundings of the robot 20, at least one GPS sensor configured to provide an estimated geolocation of the mobile robot, at least one odometer configured to measure a distance travelled by the wheels 21 of the robot 20, at least one odometer and gyroscope configured to measure relative movement of the mobile robot between two different poses, at least one accelerometer configured to measure acceleration, tilting and orientation of the mobile robot. It should be noted that the above list of further sensors that can be comprised by the mobile robot 20 is not an exhaustive list of all the sensors that can be comprised by the robot 20.

In some embodiments, at least one ToF sensor 10 can be mounted on the robot 20 at a height from the ground of 10-70 cm, preferably 20-55 cm, more preferably 40-50 cm. Further, when a plurality of ToF sensors 10 are mounted on the robot 20, at least a part of them can be mounted at the same height (or approximately at the same height) from the ground. This can facilitate combining the fields of view provided by the multiple ToF sensors mounted at the same height. Further still, when a plurality of ToF sensors 10 are mounted on the robot 20, a first set of ToF sensors 10 are mounted at a first height from the ground and a second set of ToF sensors 10 are mounted at a second height from the ground. Thus, a first extended field of view can be obtained by merging the fields of view of the first set of ToF sensors 10 and a second extended field of view can be obtained by merging the fields of view of the second set of ToF sensors 10. An even further extended field of view can be obtained by merging the first extended field of view and the second extended field of view.

Further, at least one ToF sensor 10, which can be referred to as front ToF sensor 10, can be mounted at the front of the mobile robot 20, preferably aligned near or at the middle of the front of the robot 20. The front of the robot 20, refers to the side of the robot 20 toward the direction of forward driving. If multiple front ToF sensors 10 are provided they can be distributed (e.g. equidistantly separated from each other) at the front part of the robot 20. Thus, the at least front ToF sensor 10 can provide a field of view of the front of the robot 20. If multiple front ToF sensors 10 are provided their fields of view can be combined to obtain an extended front field of view.

Further still, at least one ToF sensor 10, which can be referred to as side ToF sensor 10, can be mounted at the sides of the robot 20, preferably at the sides of the robot 20 near the front of the robot 20. Thus, the robot 20 can have a wider front field of view including a (partial) field of view at the direction of the sides of the robot 20.

For example, in FIG. 3 the robot 20 can comprise three ToF sensors 10, more particularly, a front ToF sensor 10 mounted on the front of the robot 20 and two side ToF sensors 10 mounted on the left and right side of the robot 20, near the front. Further, as depicted in FIG. 3 the ToF sensors 10 are provided approximately at the same height from the ground. This can facilitate the “merging” of the fields of view. Further still, the ToF sensors are mounted near the top of the robot 20 and preferably directed horizontally. This can provide a better field of view of the surroundings of the robot 20 (e.g. most of the field of view cannot comprise the ground or the sky, which may not comprise necessary information).

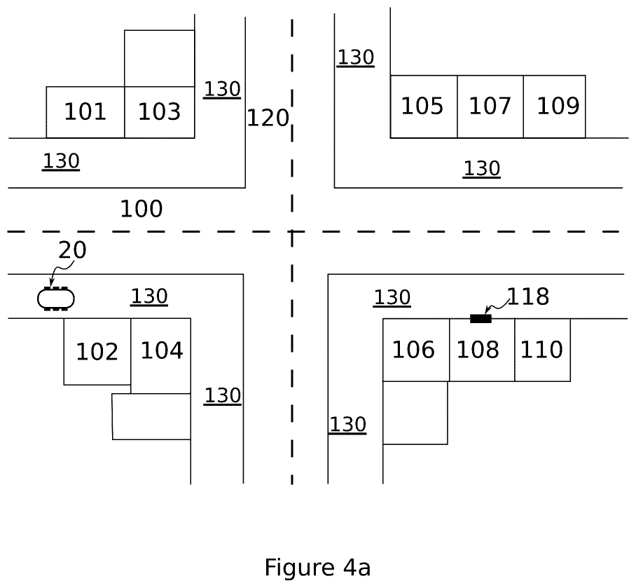

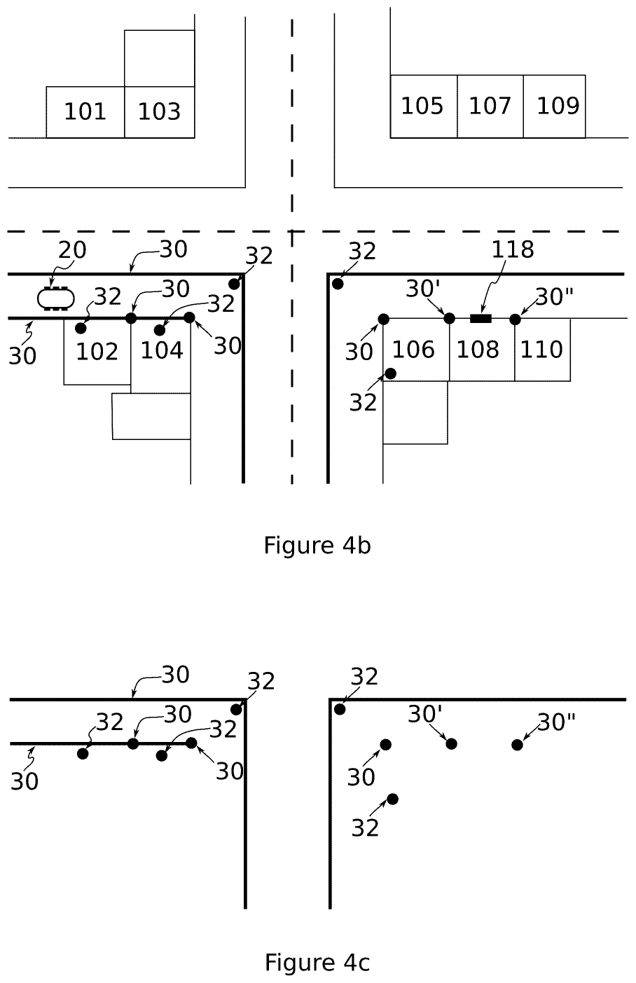

FIG. 4a depicts a situation where a mobile robot 20 is travelling in a real-world environment. The real-world environment comprises two roads 100, 120 that cross at an intersection. Next to the roads 100, 120, there may be provided sidewalks 130, and the robot may typically travel on the sidewalks 130. The sidewalks 130 may be located between the roads 100, 120 and buildings, wherein the buildings are identified by respective numbers 101 to 110 in FIG. 4a. The robot 20 may be intended to “ship” or deliver a delivery to a particular building, such as to house 108. More particularly, in the situation depicted in FIG. 4a, the robot 20 may be intended to deliver a delivery at a door 118 of house number 108.

To do so, the robot 20 has to “know” or determine when it is at the right location, i.e., in front of house number 108 at door 118. For doing that, the robot 20 may be equipped or, more generally, may have access to a map, i.e., to a 2-dimensional or 3-dimensional representation of the environment the robot 20 is travelling in. Further, this map can be encoded or stored in a machine understandable language, i.e. it can be processed by the robot 20, more particularly, by a controlling system of the robot 20, such as a processing unit, such that the robot can obtain information from the map.

To localize itself on the map, the robot 20 may sense some characteristics or features of its surroundings. Such features or characteristics may then be used to determine the robot's location on a map.

That is, in very general words, the map can comprise features associated with a position or location on the map. A position on the map or location on the map can refer to a relative position with additional information provided in the map, such as, roads, road crossings, buildings, houses, doors of houses etc. That is, a determined position on the map comprises information related to the relative position between objects comprised in the map and the determined position. The robot 20 can extract features of the surroundings and find (if possible) a match between the features it extracted and the features on the map. Once a match is found the robot can use the location on the map that can be associated to the matching features on the map and determine the robot's location.

For example, such a feature can be GPS coordinates that the robot can extract in an environment if the robot 20 comprises a GPS sensor. The GPS coordinates can be comprised on the map associated with positions on the said map. The robot 20 can find a match between the GPS coordinates output by the GPS sensor and the GPS coordinates comprised in the map. If a match can be found, the robot 20 can use the associated position on the map to the matching GPS coordinates to determine the robot's position on the map.

Generally, the accuracy of the GPS sensor is limited. For example, a GPS sensor may have an error up to 0.5 meters. For multiple applications, such as, item delivery with mobile robots, the use of GPS sensors alone for localisation may not be sufficient. As a result, the robot 20 can be configured to extract further features from the environment to improve the accuracy of localisation. The robot 20 can be configured to extract visual features from the environment, such as, straight lines 30 and/or light sources 32.

As discussed in FIG. 3, the robot 20 may comprise at least one ToF sensor 10. The robot 20 may utilize the ToF sensor 10 to capture ToF sensor images of its surroundings and obtain features, such as, visual features, from the ToF sensor images of its surroundings. These features may comprise straight lines 30, as depicted in FIG. 4b, highlighted with thicker lines 30 or as dots 30. It is noted that some lines 30 in FIG. 4b are depicted as dots to represent vertical straight lines 30. Generally speaking, the robot 20 may capture images with the ToF sensor 10 and the robot 20 may be configured to extract straight lines 30 from the images it captures. The straight lines 30, can be extracted from patterns on a ToF sensor image that have a shape of a substantially straight line. Such straight-line patterns, i.e. straight lines 30, may belong to road endings, edges of buildings, signposts, fences, etc.

Further, the robot 20 may be able to extract features 32 corresponding to light sources, referred for brevity as light sources 32, from the images of the surroundings of the robot 20, captured by the ToF sensor 10. The light source 32 may in particular belong to artificial light sources, such as streetlights, illuminated windows, traffic lights, etc.

The features that the robot 20 can extract from the exemplary environment of FIG. 4a are also depicted in FIG. 4c. This figure essentially depicts which information the robot can extract directly from the ToF sensor images it obtains, such as, straight lines 30 and light sources 32.

Generally, this information extracted from the images may not yet be sufficient for the robot to perform its delivery. To perform deliveries, it may be advantageous that the robot 20 can comprise or access additional information. Such additional information can be a “map”. The map can comprise additional information (e.g., on roads, road crossings, buildings, houses, and doors of houses) and their positions relative to the visual features 30 and 32 that can be extracted by the robot 20. For example, such a map may comprise all the information depicted in FIG. 4c. Thus, when intending to deliver a delivery at door 118 of house 108, the robot 20 “knows” from the information in the map that it needs to position itself between features 30′ and 30″. Furthermore, using the detected features (as depicted in FIG. 4c) and the information comprised in the map, the robot can determine the trajectory it needs to follow, such that, it can reach between the features 30′ and 30″ and thus at door 118 where it can deliver an item.

In the above description, it was assumed that the map that the robot can utilize for localisation can comprise all the features 30 and 32 that the robot 20 can obtain in an environment, as depicted in FIGS. 4b and 4c. That is the map was fully complete with the features 30 and 32 of the depicted environments.

However, in some embodiments, the map can only partially comprise the features 30 and 32 that can be extracted from an environment. In such instances, the robot 20 can localise itself (i.e. find its position on the map) based on the partial commonality between features that the robot 20 extracts and features comprised in the map. In other words, a matching between the features 30, 32 that the robot 20 can extract from ToF sensor images and features comprised in the map can be performed. The matching of the features can facilitate the determination of the location of the robot 20. That is, based on the relative location between the robot 20 and the detected features 30, 32 and based on the position of the detected features 30, 32 (which can be determined by matching them with corresponding—i.e. same—features on the map) the robot may determine its location on the map.

Further, if or when the robot 20 “knows” its location on the map the robot 20 can add unmatched detected features 30, 32 to the map. That is, features 30, 32 that can be extracted from the ToF sensor images and that were not previously mapped, can be added to the existing map. Hence, the robot 20 can equip or build or extend a map with additional features 30, 32.

Further, above it was assumed that the map either comprises completely or partially the features 30, 32 that can be obtained in an environment. However, in some embodiments the map may not comprise any of the features 30, 32 that can be obtained from an environment. That is, the map accessed by the mobile robot 20 may be devoid of features of the environment such as straight lines 30 and light source 32. In such embodiments, the robot 20 can be configured to add detected features 30, 32 on the map. However, this may require that firstly the robot 20 localizes itself, i.e., finds its pose on the map, before adding the information about the detected features 30, 32 or receives an input (e.g. by an operator) comprising the robots' location and/or pose. For example, the robot 20 may use other sensors, such as, GPS sensor for finding its pose on the map and further add the features 30, 32 on the map. For example, the robot 20 can be provided with a map of roads and buildings. During robot's driving, the robot 20 can localise itself (using other sensors, e.g. GPS, and/or assisted by a human operator) can detect visual features 30, 32 by capturing ToF sensor images and can add the detected visual features 30, 32 to the map. Hence, the map of roads and buildings can be extended with visual features 30, 32. This can be advantageous as visual features generally provide a better localisation accuracy compared to other methods (e.g. the use of GPS sensor).

In a further embodiment, the robot may be configured to generate a map of visual features 30, 32 utilizing ToF sensor images—more particularly features 30, 32 extracted from a ToF sensor image. That is, the robot may be configured to perform visual simultaneous localisation and mapping (VSLAM). Though an existing map may be advantageous—e.g. a map equipped with roads, addresses, road crossing, buildings etc.—it is not necessarily required for performing VSLAM. The robot through visual simultaneous localisation and mapping can be configured to generate maps of its surroundings while driving that comprise visual features 30, 32. This can further be facilitated, by enhancing the ToF sensor based VSLAM to extract addresses of roads, buildings etc., by recognizing street name signs and building number signs. Hence, a map equipped with visual features 30, 32 and additional information on roads, road crossings, buildings, houses, and doors of houses (i.e. addresses) can be generated based on ToF sensor images.

Similarly, during robot's driving, the robot 20 may receive an input (e.g. from an operator) regarding its pose on the map. The robot 20 may then use the received information to add features 30, 32 that it can detect from ToF sensor images to the map.

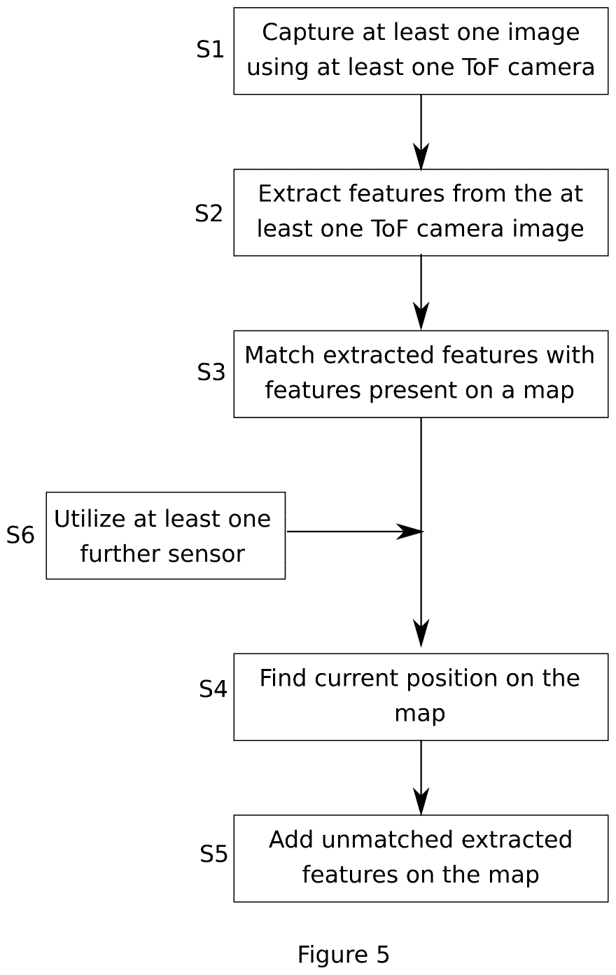

The process of localisation and mapping described above with respect to FIGS. 4a to 4c, is further detailed by the flowchart of FIG. 5.

In a step S1, at least one image can be captured with at least one ToF sensor. These images can be referred to as ToF sensor images and exemplary ToF sensor images are depicted in FIGS. 6a and 7a.

In a step S2, visual features can be extracted from the at least one image captured in step S1. For example, straight lines 30 and light sources 32 (see FIGS. 4a to 4c) can be extracted from the at least one image of the ToF sensor.

The extraction of features from a 3D ToF sensor image is further illustrated in FIGS. 6a to 6c. The extraction of features from a 2D ToF sensor image is further illustrated in FIGS. 7a to 7c. An exemplary method for the generation of a 2D and/or 3D ToF sensor image was discussed with reference to FIG. 2.

In a step S3, a map can be accessed and the features that were extracted in step S2 can be matched with features comprised in the map. Said map can be a 2-dimensional or 3-dimensional representation of the environment where the images were captured in step S1. The map can comprise additional information (e.g., on roads, road crossings, buildings, houses, and doors of houses) and their positions relative to the features that can be extracted, e.g. straight lines 30 and light sources 32.

That is, the map may comprise a set of mapped features 30, 32. The position of the mapped features 30, 32 relative to each other (and relative to other components of the map) can be comprised in or inferred from the map. From a 2D and/or 3D ToF sensor image captured in an environment (e.g. see FIG. 4a) at least one feature 30, 32 can be captured. A part or all of the extracted features 30, 32 can be comprised in the map of the environment wherein the ToF sensor image is captured. In step S3, features 30, 32 extracted from the ToF sensor image that are present on the map can be identified. That is, a matching between the extracted features 30, 32 and mapped features on the map can be done. The matching can for example, be performed such that the matching that minimized the distance (or squared distance) between matched features can be minimized. The matching algorithm may be an iterative algorithm. In a first iteration, the algorithm may generate (e.g. by guessing, randomly or pseudo randomly) a first matching between extracted and mapped features. An error can be calculated based on the distance or misalignment of the features. This error can be calculated as a sum of the squared distances between the matched features. On a next iteration a further matching can be generated. Again, the error can be calculated. On a still next iteration a still further matching can be generated and the error can be calculated. At the end, the matching with the minimum error (e.g. minimum sum of squared distances) can be determined to be the correct matching. This is based on the rationale that the correct matching would produce the minimum misalignment between the matched features.

In the above iteration algorithm optimization steps may be used to decrease the number of operations (or iterations) required to find the correct matching between the features. One such optimization may be to consider isolated features 30, 32 first. An isolated feature 30, 32 may a feature 30, 32 on a ToF sensor image that do not comprise other features 30, 32 nearby. Hence, the probability of correctly matching the isolated features may be higher (as there are no features nearby to mistake the matching). Once the isolated features 30, 32 are matched, the iterative algorithm may try to match clustered features 30, 32 (i.e. features that are close together on a ToF sensor image). However, the result of the matching of isolated features may be used herein to decrease the effort (i.e. computational complexity or number of iterations) of matching clustered features 30, 32.

Further, based on the matching of features performed in step S3, the current position on the map, more particularly the position wherein the images where captured in step S1 can be determined in step S4. That is, the correspondence of at least one extracted feature one step S2 with a mapped feature on the map can be determined during step S3. As a result, the position on the map of the matched extracted features can be obtained. Further, the relative position between the position wherein the ToF sensor images are captured (in step S1) and the position of the features extracted from the ToF sensor images can also be known (e.g. the calibration of ToF sensors provides the necessary information for obtaining the said relative position). Thus, the position on the map wherein the ToF sensor images were captured can be determined in step S4.

Alternatively (when no or not enough corresponding features are matched in step S3) or additionally (to improve the accuracy or time efficiency of localisation) at least one further sensor can be utilized, in a step S6. The at least one further sensor can include at least one GPS sensor, accelerometer, gyroscope, inertial measurement unit, odometer, visual camera, etc. The utilization of at least one further sensor can provide an estimation of the location wherein the at least one ToF sensor image was captured in step S1. This estimation can be used to disambiguate the position on the map when no or not-enough extracted features are present on the map. In other instances or embodiments, wherein a set or all the extracted features are matched with features on the map, the utilization of at least one further sensor can increase the accuracy and efficiency of finding the current position on the map, in step S4.

For example, stereo cameras can be used. The stereo cameras can be used to estimate features, such as, straight lines 30 and light sources 32 can be similarly extracted from visual images captured by the stereo cameras. Further, the position of extracted features (e.g. distance and direction) relative to the stereo cameras can be calculated.

The stereo cameras and ToF sensors 10 can be configured to comprise same or intersecting fields of view. In other words, the ToF sensor 10 and the stereo cameras can capture the same or intersecting views.

For objects in the environment that images are captured by the ToF sensor 10 and the stereo cameras, two estimations of their position can be calculated. A first estimation can be generated using at least one image from the stereo cameras and a second estimation can be generated using at least one image from the ToF sensor 10. Further, the first and the second estimation of the position of at least one object and/or visual feature, such as, straight line 30 and/or light source 32 can be used to determine a third estimation for the position of the at least one object and/or visual feature, such as, straight line 30 and/or light source 32. The third estimation may comprise a higher accuracy then the first and the second estimation. Particularly for far objects, the first estimation may be erroneous as stereo camera distance estimation may comprise higher errors for far objects. The second estimation may also be erroneous as ToF sensor, although may comprise a higher accuracy than stereo cameras for measuring the distance to objects, can suffer from distance ambiguity, particularly for far objects. However, the first estimation of the stereo cameras can be used to solve the ambiguity of the second estimation from the ToF sensor, resulting in a third estimation that can comprise the accuracy of the second estimation from the ToF sensor without the distance ambiguity.

Further, in a step S5, based on the current position obtained in step S4, the set of unmatched features (if any) in step S3 can be added to the map. Hence, step S5 facilitates the creation of a map with features, e.g. straight lines 30 and 32. Step S5 can also facilitate the equipment of an existing map with further features, e.g. straight lines 30 and 32.

The method described in FIG. 5 can be used for localisation (steps S1, S2, S3, S4 and optionally S6). The method can also be used for localisation and mapping, e.g. for simultaneous localisation and mapping (SLAM), i.e. steps S1, S2, S3, S4, S5 and S6. The method described in FIG. 5 can be used by a mobile robot 20 (see FIGS. 4a to 3c) for localisation and/or mapping. The method described in FIG. 5 can be fully carried out by the mobile robot 20, see FIGS. 4a to 4c, more particularly by a processing unit provided internally to the robot 20. However, in some other embodiments, the method of FIG. 5 can partially be carried out by the mobile robot 20 and partially by an external processing unit, such as, a server external to the robot 20 (but that can remotely communicate, i.e., exchange data with the robot 20). For example, steps S1, S2, S3, S4 and S6 can be carried out by the robot 20 and step S6 can be carried out by the external server. In general, only step S1 and S6 need to be carried out by the robot 20 (as they relate to obtaining information on the remote location) and the other steps can be distributed between the robot 20 and the external server. For example, steps that involve complex computations can be carried out by the server to improve time-efficiency.

FIG. 6a depicts an exemplary 3D image captured by a ToF sensor, that can be referred to as 3D ToF sensor image or distance image. That is, the exemplary 3D image or distance image depicted in FIG. 6a can be obtained from the output of a ToF sensor, such as, the ToF sensor 10 depicted in FIG. 1. Each pixel on the 3D image can depict a distance (or an indicator of a distance) to the corresponding area of the environment that is captured by the respective pixel. Part of the 3D ToF image, or some pixels of the 3D ToF image may not depict a distance (or indicator of the distance), e.g. represented by the black pixels in the 3D ToF image of FIG. 6a. For example, some areas may be very far away from the ToF sensor and hence they cannot be illuminated by the illumination unit 3 and/or the light reflected from them cannot reach in time the imaging sensor (e.g. the time-of-flight to such areas is higher than the exposure time of the imaging sensor) and/or the intensity of the received reflected light from some areas can be very small and undetectable by the imaging sensor 5. The distance (or an indicator of a distance) can be obtained by the ToF sensor 10 as described in FIG. 1, wherein the operation of a ToF sensor that can be utilized by present teachings is discussed.

It is noted that the exemplary 3D image depicted in FIG. 6a is depicted color coded. That is, each distance or indicative of distance provided by the pixels of the 3D image are color coded and the legend of the code is provided by the color bar 37 attached in the bottom of the image. Hence, (in this example) as instructed by the color bar legend 37, the red colors generally depict small distances from the ToF sensor that captured the image (e.g. minimum distance dₘᵢₙ) and blue and violet colors represent long distances from the ToF sensor that captured the image (e.g. maximum distance dₘₐₓ) and the rest of the colors in between red and violet representing distances within dₘᵢₙ and dₘₐₓ. In some embodiments, the minimum distance dₘᵢₙ can correspond to the distance resolution (Dᵣₑₛₒₗᵤₜᵢₒₙ) of the ToF sensor and the maximum distance dₘₐₓ can correspond to the unambiguity distance (D_{unambiguity}) of the ToF sensor discussed with respect to FIG. 1.

It is noted that the 3D image is color coded for better visual illustration purposes. Although a color code, as illustrated in FIG. 6a, can be used to represent the distances measured by the ToF sensor, in general any code can be used. In some embodiments, the 3D image captured by the ToF sensor can be represented by a m×n matrix, wherein m represents the number of pixel rows and n is the number of pixel columns. Each element of the matrix corresponds to a pixel, wherein the indexes of the element of the matrix represent the position of the pixel. The value of each element in the matrix comprises the distance or an indicative of the distance of an area of the environment captured by the pixel corresponding to the said element on the matrix. This matrix can be encoded using the color bar 37 (e.g. using a linear transformation) to produce the color-coded 3D image represented in FIG. 6a. However, said matrix that can be output by a ToF sensor can be directly processed as is, without further encoding it. Throughout the description the term 3D image or 3D ToF sensor image will be used to refer to both the original information (e.g. a matrix) as provided by a ToF sensor or to an encoded version of the original information (e.g. a color-coded image as depicted in FIG. 6a).

The 3D image can be further processed. For example, the robot 20 in FIG. 4a can comprise a processing unit that can be configured to process the 3D images that can be output by the ToF sensor 10. The processing of the 3D image can be carried out such that features, e.g. straight lines 30, can be extracted from the 3D images. That is, the processing of the 3D images aims at identifying points (i.e. interfaces between two adjacent pixels) in the 3D image wherein the distance changes abruptly (i.e. the change is larger than a predetermined threshold value, e.g. 0.5-10 cm, such as 1 cm). The predetermined threshold value can also depend on the noise of the measurements. That is, the predetermined threshold value can preferably be equal or larger then the random noise experienced during the distance measurement by the ToF sensor 10. Such pixels that are organized into substantially straight segments can further be identified. In such a manner, the straight lines 30 can be identified in the 3D image. In other words, the straight lines 30 can represent an interfacing edge between two areas of the environment wherein the distance changes abruptly.

This is illustrated in FIG. 6b, which depicts the 3D image of FIG. 6a with straight lines 30 that can be detected from such an image, superimposed therein. FIG. 6c depicts only the features (i.e. straight lines 30) that can be obtained from the 3D image. For example, the interfaces between the depicted tree (see also FIG. 7a) in the 3D image and the background (i.e. the edges of the tree) correspond to an abrupt change of distance (i.e. the tree is nearer to the ToF sensor compared to background) and hence the straight lines 30 can be identified therein.

Put simply, a 3D image that can be provided by a ToF sensor can comprise on each or some of its pixel a distance value or an indicative of a distance. Straight lines 30 can be detected from a 3D image by identifying abrupt changes of distance values (i.e. values of pixels) between neighboring pixels. For example, an edge detector algorithm can be utilized for detecting straight lines 30 in a 3D ToF sensor image.

The features, e.g. straight lines 30, extracted from the 3D image, as depicted in FIG. 6c can then be used for localisation and/or mapping as discussed with reference to the method depicted in FIG. 5. The 3D image of FIG. 6a, can be captured by a ToF sensor 10 as depicted in FIG. 1, wherein the ToF sensor 10 can be comprised by a mobile robot 20 as depicted by FIG. 4a. The processing unit that can be utilized to extract features, e.g. straight lines 30, from a 3D image can be comprised by the mobile robot 20.

FIG. 6d depicts a further exemplary 3D ToF sensor image. In the 3D ToF sensor image of FIG. 6d, the light from external light sources (i.e. light from other light sources then the illuminating unit 3) has been filtered while capturing the image with a ToF sensor 10. The filtering of external light can be achieved by emitting with the illumination unit modulated light and filtering unmodulated light that can be received by the ToF sensor 10. Alternatively, optical band pass filter can be used to filter external light.

The filtering of external light sources can be advantageous. A strong light source can oversaturate the imaging sensor 5. As a result, the active illumination generated by the illumination unit 3 can be hard to sense. By filtering the external light sources the signal-to-noise ratio at the imaging sensor 5 can be increased and ToF sensor measurement accuracy can be improved (as discussed with reference to FIG. 9).

By filtering external light, the light sources on the captured environment of the ToF sensor 10 can appear on a 3D ToF sensor image as blobs or black areas or areas on an image without distance measurement or output from respective photosensitive elements 50, as illustrated by the black blob on FIG. 6d representing a light source 32 (more particularly the Sun in this example). Thus, using blob detection algorithms the light sources 32 may be determined on a 3D image and may be extracted from therein.

Alternatively, in embodiments wherein filtering is not used, the black blob 32, may be created due to oversaturation of the pixels 50 of the imaging sensor 5 that measured intensity of the light originating from a (strong) light source. Due to physical constraints, each pixel 50 of the imaging sensor comprises a maximum intensity (or irradiance) that it can measure. In the absence of noise, a one-to-one mapping from measured irradiance to a sensor output (e.g. pixel intensity on image) can be fully described by a function (referred to as radiometric response function) which is defined only for irradiance values smaller than the maximum irradiance that can be measured. Thus, oversaturated pixels will provide erroneous reading. The oversaturated pixels can be identified and their values neglected or treated as missing values (i.e. Null values).

As illustrated in the example in FIG. 6d, the oversaturated pixels can be used to identify light sources 32 in a 3D ToF sensor image. More particularly, the presence of a light source can oversaturate an area on the imaging sensor 5 comprising multiple pixels 50. As such, in the 3D ToF sensor image black blobs 32 can appear—which can be identified of corresponding to light sources.

In other words, “black” blobs 32 in a 3D ToF sensor image may appear due to filtering of received light or oversaturation of (part of) the image sensor 5. This can allow identification of light sources in a 3D ToF sensor image.

In FIG. 7a a 2D image that can be captured by a ToF sensor is depicted. For example, the ToF sensor 10 depicted in FIG. 1 can be configured to capture the 2D image depicted in FIG. 7a. In such embodiments, the ToF sensor operates in a similar manner that a visual camera operates. Instead of sensing visible light, the ToF sensor can be configured to sense infra-red light, or near-infrared light, such as, electromagnetic waves with wavelengths between 700-1400 nm, preferably 750-1050 nm. In other words, each pixel of the 2D image can comprise a value that can indicate the amount of sensed or received infra-red light (or the amount of charge that the received infra-red light can induce in the sensor of the ToF sensor). For example, the intensity of the received light can be measured on each photo sensitive element 50 of the imaging sensor 5 (see FIG. 1).

That is, the ToF sensor can be configured for the so-called grayscale imaging. In this mode, the ToF sensor does not calculate depth images. Instead, the ToF sensor can be configured to simply sense the intensity of the received light (similar to a visual camera). In this mode, the ToF sensor can be configured to operate with active illumination or without active illumination. In the former case (with active illumination) the environment can be illuminated with light (e.g. infrared light). The received light may be filtered such that only light that is emitted by the ToF sensor can be received. In the latter case (without active illumination), the ambient light can be measured.

To improve the accuracy of capturing a 2D ToF sensor image the ToF sensor 10, more particularly the imaging sensor 5, can be calibrated to compensate for pixel brightness offset. The brightness calibration can be performed by covering the imaging sensor 5, such that, it receives no light, and an image is capture, which can be referred to as a brightness calibration image. Normally, the brightness measurements provided by the imaging sensor 5 should be “zero”. However due to brightness offset (e.g. due to manufacturing errors of the imaging sensor 5) the measurements may not be zero. By subtracting the brightness calibration image from images captured by the TOF sensor, the brightness offset can be compensated for.

The 2D ToF sensor image can be processed such that features can be detected therein. For example, the 2D ToF sensor image can be processed by an edge detection algorithm such that straight lines 30 can be detected therein. The 2D ToF sensor image can also be processed such that light sources 32 can be detected therein, for example, using brightness thresholding. This is illustrated in FIG. 7b, which depicts the 2D ToF sensor image of FIG. 7a with features 30, 32 that can be detected superimposed on the image. FIG. 7c depicts only the features that can be extracted from the 2D ToF sensor image. As it can be noticed, straight lines 30 and light sources 32 can be extracted from the 2D ToF sensor images. Further, the straight lines 30 and light sources 32 can be extracted from a 2D ToF sensor image irrespective of the time of the day or night, or in general, irrespective of visible light conditions—as the ToF sensor artificially illuminates the environment it captures with IR light (or near IR light), see illumination unit 3 of the ToF sensor 10 in FIG. 1.

The ToF sensor, as discussed, generally operates with IR lights (i.e. electromagnetic waves in the IR part of the spectrum). It can be used to capture 3D images, as illustrated in FIG. 6a, or 2D images, as illustrated in FIG. 7a. As further discussed with reference to FIGS. 6c and 7c, features, such as straight lines 30 and light sources 32, can be extracted from the captured images. These features, as discussed in FIGS. 4 and 5 can be used for localisation and/or mapping purposes.

In the current state of the art, the use of visual cameras (i.e. cameras operating with visible light) has been suggested for facilitating localisation and/or mapping. The images captured by the visual cameras can be processed, such that, straight lines can be extracted from therein. The European patent application EP 17199772.9 further suggests the use of nighttime features (such as, light sources) extracted from images captured at reduced light conditions (e.g. at night) and using the night-time features for localisation and/or mapping during reduced light conditions.

As the visual camera and the ToF sensor operate at similar frequencies (i.e. neighboring bands of the electromagnetic spectrum), it can be expected that the features (e.g. straight lines 30 and light sources 32) captured by a visual camera are similar with features (e.g. straight lines 30 and light sources 32) captured by a ToF sensor. Thus, features extracted from visual cameras and ToF sensors can be combined to increase accuracy of localisation and/or mapping. That is, the robot 20 depicted in FIG. 3, can further comprise visual cameras configured to capture visual images. Thus, the robot can capture visual images and ToF sensor images. For the captured images the robot can extract visual features 30, 32 and can use the features 30, 32 extracted from both visual images and ToF sensor images for localisation and/or mapping.

Further, the ToF sensor can artificially illuminate the environment using the illumination unit 3. Hence, the ToF sensor will be able to “see” also at night, in reduced visual light conditions. Thus, it can be particularly more advantageous as compared to a visual camera to be used at reduced light conditions. Additionally, a visual camera would require long exposure times at reduced light conditions for capturing visual images. On the other hand, the ToF sensor can capture images with shorter exposure times at low light conditions, such as at night (as it is actually not dark for the ToF sensor, since it is sensitive to IR light and the scene can be illuminated with IR light using the illumination unit 3, see FIG. 1). The short exposure time provides little motion blur, hence, a better quality of the captured images. For example, reduced motion blur can make the edges more visible and hence straight lines 30 can be detected with a better accuracy.

It is to be noted that active illumination can also be used for visual cameras. However, the provision of active illumination for visual cameras requires emitting visual light. For example, a high-power flash of visual light can be emitted, while the visual cameras capture images. This can increase the illumination of the environment for the visual cameras. Hence the exposure time of the visual cameras can be reduced and motion blur as well. However, emitting high power flashes of light is not generally possible as it can cause distractions to the traffic participants—e.g. pedestrians, drivers, cyclists, etc.—which may become a cause of accidents. As such, in general, only the emission of low power (usually continuous) light is performed for emitting the environment—e.g. with headlights. Since the environment is illuminated with low power light, high camera exposure time may need to be used while capturing visual images to improve image brightness. The same issue is not present for ToF sensor. As the illumination required by the ToF sensor is not visible to the human eye, the illumination for the ToF sensors can be flashed at high power during the time the ToF sensors capture images, without distracting the people being exposed to it, such as, pedestrians, cyclers or drivers. Moreover, the illumination for the ToF sensor can be flashed only for a brief moment (e.g. only during the exposure time of the ToF sensor), this way it does not become an eye hazard for the people being exposed to it. Since during the exposure time of the ToF sensor the environment is brightly lit with infrared light, the exposure time of the ToF sensors may be reduced which can cause reduction in motion blur. This makes the ToF sensors advantageous for use particularly at low light conditions.

Further, extracting the straight lines 30 and light sources 32 on a ToF sensor image can be particularly advantageous for merging a set of map data comprising daytime features (i.e. features that can be extracted from an image captured at good light conditions), such as, straight lines 30 with another set of map data comprising nighttime features (i.e. features extracted from an image captured at reduced light conditions), such as, light sources 32.

This issue is also addressed by the European patent application EP 17199772.9. In this patent application, the use of visual cameras for localisation and mapping is disclosed. However, during daytime, the light sources are usually turned-off, thus, they do not appear on a visual image captured at good light conditions, such as during daytime. Mostly straight lines 30 appear on a visual image captured during daytime. On the other hand, on visual images captured at reduced light conditions, straight lines are barely visible while light sources are easily visible. Hence, features extracted from visual images captured at daytime, that mostly comprise straight lines, may not correspond (or the correspondence may be low) to features extracted during reduced light conditions that mostly comprise light sources. Thus, one may only utilize straight line based localisation during daytime and light-source based localisation during reduced light conditions (e.g. night). This may require the use of two maps, one with straight lines and one with light sources. But this may be inefficient, for example it may require more effort for mapping and large storage space for the maps.

It can be more advantageous having a single map comprising both straight lines and light sources features. This map can then be used irrespective of light conditions. However, the creation of the single map requires the merging of the features extracted during daytime with features extracted during reduced light conditions. Further the merging of the features extracted during daytime with features extracted during reduced light conditions may require that the relative position between these two sets of features be known in advance. Since these two sets of features do not match (when extracted from visible camera images) the relative position between the two sets cannot be directly obtained from visual images captured at daytime or reduced light conditions. As a result, the merging of the two sets of features can be complex or inaccurate.

In the European patent application EP 17199772.9, the said issue of merging the two sets of features is addressed by increasing the commonality between the two sets of features extracted from visual image. This is achieved, by capturing images using a visual camera at twilight. Twilight, as described therein, is a particularly advantageous time as there is enough light for the straight lines to be visible while at the same time most of the light sources are turned-on—hence making them visible on the images captured by visual cameras. As a result, light sources and straight lines can be captured in one image, which facilities creating a map with both types of features (as the relative position between the two sets can be determined since they are extracted from the same visual images).

In the current teachings, the use of ToF sensor images is suggested as a solution of the issue of merging the discussed two sets of features. As it can be seen in FIG. 7c, in a ToF sensor image both types of features (straight lines 30 and light sources 32) can be extracted. This can facilitate the creation of a map comprising daytime features (straight lines 30) and nighttime features (light sources 32).

Put simply, during reduced light conditions both straight lines 30 and light sources 32 can be visible and extracted from ToF sensor images. This can facilitate localisation at reduced light conditions. It can further facilitate the creation of a single map comprising both straight lines 30 and light sources 32.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, a preferred embodiment has been described with reference to the accompanying drawings, the skilled person will understand that this embodiment was provided for illustrative purpose only and should by no means be construed to limit the scope of the present invention, which is defined by the claims.

1. A method for localisation comprising
(a) providing at least one time-of-flight (ToF) sensor, map data and a processing unit;
(b) the at least one ToF sensor capturing at least one ToF sensor image comprising at least one feature;
(c) the processing unit extracting at least one feature from the at least one ToF sensor image;
(d) the processing unit comparing the at least one extracted feature with the map data; and
(e) generating a location hypothesis based on the comparing in step (d).

2. The method according to claim 1, wherein step (c) comprises extracting straight lines and wherein extracting straight lines from a ToF sensor image comprises recognizing patterns on the ToF sensor image that have a shape of a substantially straight line.

3. The method according to claim 1, wherein step (c) comprises extracting light sources from a ToF sensor image and wherein light sources are extracted from a ToF sensor image by recognizing stationary light sources captured on the ToF sensor image.

4. The method according to claim 1, wherein step (b) comprises capturing at least one 3D (3-dimensional) ToF sensor image, wherein each pixel of the 3D ToF sensor image comprises a distance to a respective object and/or surface on the field of view of the ToF sensor and wherein the 3D ToF sensor image is captured by
emitting with an illumination unit a measuring signal comprising infrared light, such as electromagnetic waves with wavelengths between 700-1400 nm, preferably between 750-1050 nm, and
receiving with an imaging sensor the measuring signal after the measuring signal is reflected by the surface on the field of view of the ToF sensor and
estimating the distance to an object and/or surface in the field of view of the ToF sensor based on at least one of:
a time-of-flight of the measuring signal and
a difference between the emitted measuring signal and received measuring signal.

5. The method according to claim 1, wherein step (b) comprises capturing at least one 2D ToF sensor image, such as, a grayscale image and wherein capturing the 2D ToF sensor image comprises:
emitting active illumination comprising infrared light, such as electromagnetic waves with wavelengths between 700-1400 nm, preferably 750-1050 nm and
receiving the emitted illumination after being reflected by the surface on the field of view of the ToF sensor and
measuring the intensity of the received illumination.

6. The method according to claim 1,
wherein step (d) comprises finding an intersection set of features of the at least one extracted feature and the map data, wherein the intersection set of features comprises features that are extracted from the at least one ToF sensor image and are mapped on the map and
wherein the location hypothesis in step (e) is generated based on a known position on the map of the features comprised in the intersection set of features and the relative position between ToF sensor and the location of the features comprised in the intersection set of features.

7. The method according to claim 6, wherein the relative complement set of features of the map data in the at least one extracted feature is added to the map based on the location hypothesis generated in step (e), wherein the said relative complement set of features comprises features that are extracted from the at least one ToF sensor image but are not mapped in the map.

8. The method according to claim 1, further comprising providing at least one visual camera configured to capture at least one visual image comprising features and
wherein the features comprise at least one of: straight lines and light sources and
wherein the processing unit extracts the features from the at least one visual image.

9. The method according to claim 8, wherein a first set of features is extracted from at least one ToF sensor image and a second set of features is extracted from at least one visual image and wherein location hypothesis in step (e) is generated based on the first set of features and the second set of features, and
wherein the first set of features is used to calibrate the at least one visual camera and the second set of features is used to calibrate the at least one ToF sensor.

10. The method according to claim 1, further comprising
providing a daytime map and a night-time map, wherein the daytime map comprises daytime features dominantly comprising straight lines and the night-time map comprises night-time features dominantly comprising light sources and
merging the daytime map and the night-time map into a single map by determining the relative position between daytime features and the night-time features and
wherein the relative position between daytime features and the night-time features is determined based on the relative position between the extracted features from a ToF sensor image.

11. The method according to claim 10, the method further comprises determining a third intersection set of features between the extracted features from a ToF sensor image and daytime features comprised in the daytime map and a fourth intersection set of features between the extracted features from a ToF sensor image and night-time features comprised in the night-time map; and
wherein the relative position between the third intersection set of features and the fourth intersection set of features is inferred based on the position of the extracted features on a ToF sensor image, and
wherein the relative position between the third intersection set of features and the fourth intersection set of features is used to align the daytime features comprised in the daytime map and the night-time features comprised in the night-time map.

12. The method according to claim 1, wherein a mobile robot comprises the at least one ToF sensor and wherein the method comprises determining a location of the mobile robot based on the location hypothesis generated at step (e).

13. The method according to claim 12, wherein the mobile robot comprises the processing unit.

14. A localisation system comprising:
at least one time-of-flight (ToF) sensor configured to capture at least one ToF sensor image;
a memory unit, comprising stored therein map data; and
a processing unit configured to
extract at least one feature from the at least one ToF sensor image and
access the memory unit comprising the map data and compare the at least one extracted feature with the map data and
generate a location hypothesis based on the comparison of the at least one extracted feature with the map data.

15. The system according to claim 14, wherein the ToF sensor comprises
at least one illumination unit, such as, a laser diode or light emitting diode configured to emit infrared light, such as electromagnetic waves with wavelengths between 700-1400 nm, preferably between 750-1050 nm and
an imaging sensor configured to be sensitive to infrared light, such as electromagnetic waves with wavelengths between 700-1400 nm, preferably 750-1050 nm.

16. The system according to claim 14, wherein the system further comprises a mobile robot configured for land-based motion and wherein the mobile robot comprises the at least one ToF sensor.

17. The system according to claim 16, wherein the mobile robot comprises at least one front ToF sensor mounted on a front of the mobile robot and at least one ToF sensor mounted on the sides of the mobile robot, at a height from the ground of 10-70 cm, preferably, 20-55 cm, more preferably 40-50 cm.

18. The system according to claim 14, wherein the mobile robot comprises at least one visual camera, preferably, at least one visual stereo camera.

19. The system according to claim 14, wherein the mobile robot comprises the processing unit.

20. The system according to claim 14, wherein the system further comprises a server and wherein the server comprises the processing unit.
